(19) United States
(12) Patent Application Publication
(10) Pub. No.: US 2002/0198695 A1
(43) Pub. Date: Dec. 26, 2002

(54) Method for large timesteps in molecular modeling

(75) Inventors: Michael A. Sherman, Mountain View, CA (US); Dan E. Rosenthal, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Protein Mechanics, Inc., Mountain View, CA

(21) Appl. No.: 10/053,253

(22) Filed: Nov. 2, 2001

Related U.S. Application Data
(60) Provisional application No. 60/245,688, filed on Nov. 2, 2000.
(60) Provisional application No. 60/245,730, filed on Nov. 2, 2000.
(60) Provisional application No. 60/245,731, filed on Nov. 2, 2000.
(60) Provisional application No. 60/245,734, filed on Nov. 2, 2000.

(51) Int. Cl. G06G 7/48; G06G 7/58

(52) U.S. Cl. 703/11; 703/12

(57) ABSTRACT

For the computer modeling of molecules, a model with reduced coordinates is used with sufficiently stable implicit integration methods integrating the model's equations of motion. The timesteps in the integration method can vary in a range over 100 to greatly increase the computer's efficiency and to hasten the computational results. Both static analysis and molecular dynamics simulations are some ready applications.

### CROSS-REFERENCES TO RELATED APPLICATIONS

This application is entitled to the benefit of the priority filing dates of Provisional Patent Application No. 60/245,688, filed Nov. 2, 2000, and in addition, No. 60/245,730, filed Nov. 2, 2000; No. 60/245,731, filed Nov. 2, 2000; and No. 60/245,734, filed Nov. 2, 2000; all of which are hereby incorporated by reference.

### BACKGROUND OF THE INVENTION

The present invention is related to the field of molecular modeling and, more particularly, to computer-implemented methods for the prediction of the behavior and properties of a molecule or systems of interacting molecules in solution. The invention pertains to computations that exploit molecular mechanics models and time integration to perform the desired predictions.

The motions of bodies in molecular mechanics are determined by Newton's Laws of Motion. For a body of mass m, subject to a force F, Newton's Second Law states:

F=ma

or the acceleration a of the body is proportional to the total force upon the body. This simple equation hides enormous complexity for the dynamic modeling of large molecules. The acceleration of the body is the time derivative of velocity of the body and to determine the velocity of the body, its acceleration must be integrated with respect to time. Likewise, the velocity of a body is the time derivative of position of the body and to determine the position of the body, its velocity must be integrated with respect to time. Thus with knowledge of the force upon a body, integration operations must be performed to determine the velocity and position of the body at a given time.

In a molecule, there are multiple bodies whose motions must be considered. In a typical molecular mechanics model, each atom of a molecule is considered a body, and each of these is subject to multiple and complex forces potentially involving the current locations of every other atom in every molecule in the system as well as environmental or solvent influences. Thus the calculation of the motion and the shape of the molecule requires the determination of the position and motion of each atom in the system. Hence the calculation of the structure, dynamics and thermodynamics of molecules, including complex molecules having thousands of atoms, would seem a task well suited to computers.

Indeed, the field of molecular modeling has successfully simulated the motion (molecular dynamics or (MD)) and determined energy minima or rest states (static analysis) of many complex molecular systems by computers. Typical molecular modeling applications have included enzyme-ligand docking, molecular diffusion, reaction pathways, phase transitions, and protein folding studies. Researchers in the biological sciences and the pharmaceutical, polymer, and chemical industries are beginning to use these techniques to understand the nature of chemical processes in complex molecules and to design new drugs and materials accordingly. Naturally, the acceptance of these tools is based on several factors, including the accuracy of the results in representing reality, the size and complexity of the molecular systems that can be modeled, and the speed by which the solutions are obtained. Accuracy of many computations has been compared to experiment and generally found to be adequate within specified bounds. However, the use of these tools in the prior art has required enormous computing power to model molecules or molecular systems of even modest size to obtain molecular time histories of sufficient length to be useful.

There are two sources of computational complexity for molecular modeling tasks involving time integration:

1. The particular molecular model which is used to describe the locations, velocities and mass properties of the constituent atoms, the inter-atomic forces between them, and the interactions between the atoms and their surrounding environment; and

2. The particular numerical method used to advance the model through time. Time is advanced repeatedly by very short intervals, called timesteps, until a final time has been reached.

In common practice, the molecular model consists of the Cartesian (x,y,z) coordinates and velocities of each individual atom of the solute molecules, coupled with a model of the solvent environment composed either of individual solvent molecules (explicit solvent) or an analytical approximation of the bulk properties of the solvent (implicit solvent). The numerical method consists of the leapfrog Verlet integrator or similar simple integration method. (This method was first discussed by Verlet, “Computer ‘Experiments’ on Classical Fluids: I. Thermodynamical Properties of Lennard-Jones Molecules,” Phys. Rev., 159(1):98-103, July 1967).

Substantial work has been completed in reducing the computational load for molecular models, such as the reduction of model complexity by constraining higher order modes with rigid body assumptions, simplifying the model with rigid or flexible substructuring, Order(N) dynamics, efficient implicit solvent models, and multipole methods for the force field models (see, for example, U.S. Pat. No. 5,424,963 on the commercial MBO(N)D software package).

Heretofore molecular simulations have been very slow because current numerical methods require very small timesteps, typically between 1 and 10 femtoseconds (10⁻¹⁵ to 10⁻¹⁴ seconds). Each timestep taken requires the computation of a new state (position and motion for each atom) of the particular molecular model, and then computation of the new set of forces resulting from the new state. For example, molecular dynamics simulations of the complex behavior of large molecules, such as the folding of a protein, typically need to cover a time span from at least a microsecond up to several seconds or even minutes. With techniques currently in common use, this results in the requirement to take 10⁹ to 10¹⁶ timesteps in the computer simulation. The per-step computations of the state, and especially the forces, grow very expensive as the problem size increases. Even with the fastest computers available today, months, years or even centuries of computer time are required to solve such problems even for systems of modest size.

One could achieve an enormous improvement in the speed and size of the molecular modeling problems that could be solved if the timestep could be greatly increased while maintaining an accurate model of the chemical and physical processes. It has been widely believed by molecular dynamicists that these small timesteps are an inevitable requirement of the need to maintain accuracy in the presence of the very high frequencies to be found in vibrations of molecular bonds. For example, see Leach, Molecular Modelling Principles and Applications, 1996, p. 328; Berendsen, in Computational Molecular Dynamics: Challenges, Methods, Ideas Deuflhard et al. (ed.), Springer, 1999, pg. 18; Rapaport, The Art of Molecular Dynamics Simulation, Cambridge, 1995, reprinted with corrections 1998, p. 57; and U.S. Pat. No. 5,424,963.

This common-sense belief is incorrect, however. The computer science sub-discipline of numerical analysis has produced an extensive theory of numerical integration for problems in which high frequencies exist but are of little interest. These problems are termed “stiff” problems (see, for example, Hairer and Wanner, Solving Ordinary Differential Equations II: Stiff and Differential-Algebraic Problems, 2^{nd} ed., Springer, 1996). In these cases, it is the stability of the integration method, not the required solution accuracy, which limits the timestep. Integrators vary widely in their stability properties, which may be rigorously characterized by their stability regions or stability intervals. Explicit integration methods, which are simple to implement and of which Verlet is an example, always have very limited stability regions.

On the other hand, implicit integration methods, which are much more complicated than explicit methods, can have much larger stability regions. In fact, implicit integration methods exist which have unconditional stability. This means that, in theory, the method can take arbitrarily large timesteps. Such methods have a mathematical property called “L-stability.” Hence the choice of “sufficiently stable” integration methods allows, for a given model and desired calculation, step sizes to be limited only by inherent accuracy requirements. In practice, only implicit methods will be sufficiently stable. L-stable methods are always sufficiently stable. Further, only implicit integration methods can be L-stable, but very few implicit integration methods actually are L-stable. Stated differently, L-stable integration methods are a subset of sufficiently stable implicit integration methods, which are themselves a subset of all implicit integration methods.

In the present discussion, “large timesteps” are timesteps whose size is limited only by inherent accuracy requirements or internal convergence requirements and not by stability limits of the integration method. In practice, any timestep of 200 femtoseconds (fs) or larger encountered in molecular dynamics is almost certain to be “large” by this definition, but in most applications many much smaller timesteps should be considered large. For systems incorporating covalent bond-stretch terms, stepsizes are limited to 2 fs by Verlet stability concerns. For systems with bond-stretch eliminated through the use of rigid body models, Verlet stability typically limits stepsizes to below 40 fs.

Some molecular dynamicists have experimented with implicit methods and rejected them as impractical. See, for example, see Schlick, Computational Molecular Dynamics: Challenges, Methods, Ideas, Deuflhard et al. (ed.), Springer, 1999, p. 238. In particular, the propensity of stable methods to remove energy from a simulation through induced damping was considered a fatal flaw, as has been the large amount of computing time required by the nonlinear system at each timestep. See Schlick, op. cit., pp. 238-9, and 244. The damping effect was considered a critical flaw because most molecular dynamics simulations are required to conserve energy. In Schlick's review cited above, the molecular models included Langevin terms that introduced artificial forces to restore the energy lost due to explicit damping and due to the stable integration method. These forces actually prevent the stable method from taking the large timesteps, as desired. Although implicit methods can be used effectively in such computations, there are also many molecular modeling computations which do not need to conserve energy and our methods are particularly effective for those problems. We will teach how to employ implicit methods effectively in practical computations through judicious modeling choices and careful implementation.

As a result of the lack of success with implicit methods in the prior art, current molecular modeling simulation tools rely primarily on energy conserving, symplectic explicit integration methods that were first discussed in 1967 by Verlet. Variations of these integration methods, such as leapfrog or velocity Verlet and modified Beeman, are available in current molecular dynamics codes such as Tinker (Jay Ponder, TINKER User's Guide, Version 3.8, October 2000, Washington University, St. Louis, Mo.).

Other recent attempts to increase timestep size by separating the low and high frequency components or by constraining the high-frequency bond vibrations combined with special Verlet-derived integrators, such as SHAKE and RATTLE, have had limited success in increasing timestep size. Speedup factors of only 2 to 5 have been achieved (See Eric Barth et. al., “A separating framework for increasing the timestep in molecular dynamics,” Computer Simulation of Biomolecular Systems, Vol 3., pp. 97-121, 1997).

In summary, molecular modeling, especially molecular dynamics simulation, efforts have been stymied by small stepsizes. Integration is still performed in very small timesteps with the resulting computation extremely laborious and the results long in coming. The impediment to useful application in molecular research is clear. A molecular dynamics simulation that takes a year to obtain a result cannot be used for practical research. In contrast, the present invention teaches methods that permit integration in large timesteps so that useful and accurate computational results are quickly generated.

To avoid these problems, the present invention teaches a method to reduce computation time when calculating particular behaviors or properties of interest.

### SUMMARY OF THE INVENTION

The present invention teaches a method of calculating behavior or properties of a system of molecules in an environment, comprising mathematically modeling the molecular system with environmental effects and equations of motion for the molecules expressed in reduced coordinates; and integrating the model equations with a sufficiently stable integrator in large timesteps so as to obtain accurate calculations of the desired behavior and properties. The method includes varying the size of the timesteps in accordance with accuracy and convergence requirements for optimum use of computing time. The size of the timesteps can vary in the range of at least 100.

The preferred reduced-coordinate molecular model is a rigid-body partitioning incorporating torsion angle coordinates, rather than Cartesian all-atom coordinates. Preferred sufficiently stable integration methods include the L-stable one-step method Radau5 for error-controlled dynamic computations, and the L-stable Implicit Euler method for energy minimizing (static) computations. For applications with less-stringent stability requirements, the highly stable and efficient implicit multistep method DASSL is preferred.

### BRIEF DESCRIPTION OF THE DRAWINGS

FIG. 1 is a representational block module diagram of the software system architecture in accordance with the present invention;

FIG. 2 illustrates the tree structure of the multibody system of the molecular model according to the present invention;

FIG. 3 illustrates the reference configuration of the FIG. 2 multibody system;

FIG. 4A illustrate a sliding joint between two bodies of the FIG. 2 multibody system;

FIG. 4B illustrate a pin joint between two bodies of the FIG. 2 multibody system;

FIG. 4C illustrate a ball joint between two bodies of the FIG. 2 multibody system;

FIG. 5A illustrates the stability function, A-stability test and L-stability test of the implicit Euler integration method;

FIG. 5B illustrates the stability function, A-stability test and L-stability test of the implicit midpoint integration method;

FIG. 5C illustrates the stability function, A-stability test and L-stability test of the Radau5 integration method;

FIG. 6 is a flow chart illustrating the steps of an implicit Euler integration method according to one embodiment of the present invention;

FIG. 7 is a flow chart illustrating the steps of a Radau5 integration method according to another embodiment of the present invention;

FIG. 8 is a representation of the molecular structure of the protein fragment alanine dipeptide;

FIG. 9A is a plot of the coordinate angle ψ versus time for the FIG. 8 alanine dipeptide model as calculated by the Verlet integration method;

FIG. 9B is a plot of the coordinate angle ψ versus time for the FIG. 8 alanine dipeptide model as calculated by the Radau5 integration method;

FIG. 9C is a plot of the coordinate angle ψ versus time for the FIG. 8 alanine dipeptide model as calculated by the implicit Euler integration method;

FIG. 9D is a plot of the coordinate angle φ versus time for the FIG. 8 alanine dipeptide model as calculated by Verlet integration method;

FIG. 9E is a plot of the coordinate angle φ versus time for the FIG. 8 alanine dipeptide model as calculated by the Radau 5 integration method; and

FIG. 9F is a plot of the coordinate angle φ versus time for the FIG. 8 alanine dipeptide model as calculated by the implicit Euler integration method; and

FIG. 10A is a plot of the timestep size versus time for the FIGS. 9A and 9D alanine dipeptide coordinate simulation by the Verlet integration method;

FIG. 10B is a plot of the timestep size versus time for the FIGS. 9B and 9E alanine dipeptide coordinate simulation by the Radau5 integration method; and

FIG. 10C is a plot of the timestep size versus time for the FIGS. 9C and 9F alanine dipeptide coordinate simulation by the implicit Euler integration method.

### DESCRIPTION OF THE SPECIFIC EMBODIMENTS

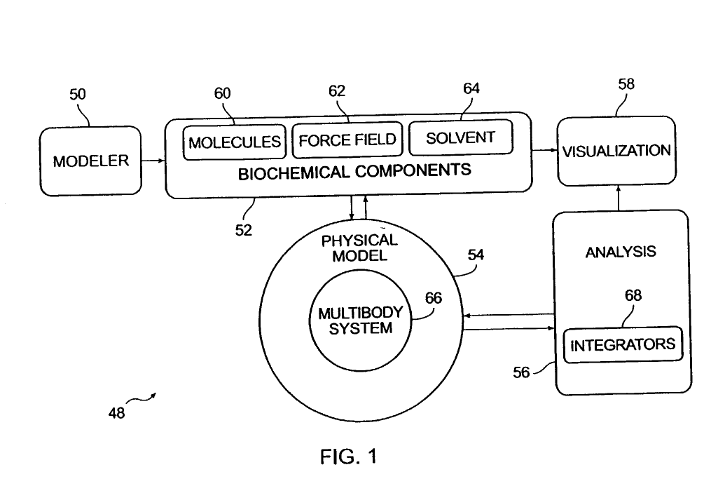

The general system architecture 48 of the software and some of its processes for modeling molecules in accordance with the present invention are illustrated in FIG. 1. Each large rectangular block represents a software module and arrows represent information which passes between the software modules. The software system architecture has a modeler module 50, a biochem components module 52, a physical model module 54, an analysis module 56 and a visualization module 58. The details of some of these modules are described below; other modules are available to the public.

The modeler module 50 provides an interface for the user to enter the physical parameters which define a particular molecular system. The interface may have a graphical or data file input (or both). The biochem components module 52 translates the modeler input for a particular mathematical model of the molecular system and is divided into translation submodules 60, 62 and 64 for mathematical modeling the molecule(s), the force fields and the solvent respectively of the system being modeled. There are several modeler and biochem components modules available including, for example, Tinker (Jay Ponder, TINKER User's Guide, Version 3.8, October 2000, Washington University, St. Louis, Mo.).

With the translated physical parameters from the biochem components module 52, the physical model module 54 defines the molecular system mathematically. At the core of the module 54 is a multibody system submodule 66. The physical model module 54 and multibody system submodule 66 are described below in detail. Co-pending applications, U.S. patent application Ser. No. ______, entitled “METHOD FOR ANALYTICAL JACOBIAN COMPUTATION IN MOLECULAR MODELING,” and U.S. application Ser. No. ______, entitled “METHOD FOR RESIDUAL FORM IN MOLECULAR MODELING,” both filed of even date and which claim priority from the previously cited provisional patent applications, are assigned to the present assignee and are incorporated by reference herein have further descriptions of the physical model module 54 and multibody submodule 66 from the perspective of the inventions disclosed in those patent applications.

The analysis module 56, which communicates with the physical model module 54 and the visualization module 58, provides solutions to the computational models of the molecular systems defined by the physical model module 54. The analysis module 56 consists of a set of integrator submodules 68 which integrate the differential equations of the physical model module 54. The integrator submodules 68 advance the molecular system through time and also provide for static analyses used in determining the minimum energy configuration of the molecular system. It is the analysis module 56 and its integrator submodules 68 which contains most of the subject matter of the present invention and are described in detail below.

The visualization module 58 receives input information from the biochem components module 52 and the analysis module 56 to provide the user with a three-dimensional graphical representation of the molecular system and the solutions obtained for the molecular system. Many visualization modules are presently available, an example being VMD (A. Dalke, et al., VMD User's Guide, Version 1.5, June 2000, Theoretical Biophysics Group, University of Illinois, Urbana, Ill.).

Molecular Model and Multibody System Description

The integrators described below operate upon a set of equations which describe the motion of the molecular model in terms of a multibody system (MBS). To aid the computation of the integration methods described in detail below, a torsion angle, rigid body model is used to describe the subject molecule system, in accordance with the present invention. Internal coordinates (selected generalized coordinates and speeds) are used to describe the states of the molecule.

The MBS is an abstraction of the atoms and effectively rigid bonds that make up the molecular system being modeled and is selected to simplify the actual physical system, the molecule in its environment, without losing the features important to the problem being addressed by the simulation. With respect to the general system architecture illustrated in FIG. 1, the MBS does not include the electrostatic charge or other energetic interactions between atoms nor the model of the solvent in which the molecules are immersed. The force fields are modeled in the submodule 62 and the solvent in the submodule 64 in the biochem components module 52.

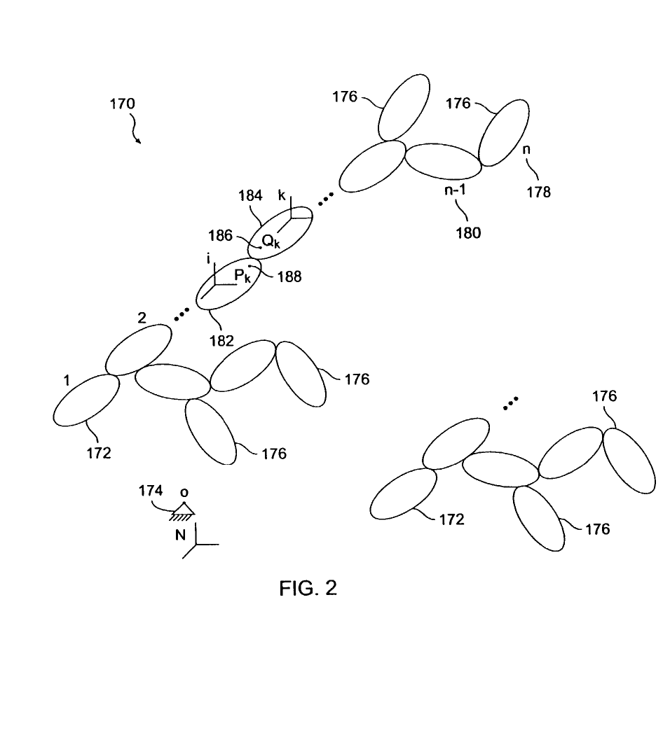

FIG. 2 illustrates the tree structure of the MBS of a subject molecule. The basic abstraction of the MBS is that of one or more collections of hinge-connected rigid bodies 170. A rigid body is a mathematical abstraction of a physical body in which all the particles making up the body have fixed positions relative to each other. No flexing or other relative motion is allowed. A hinge connection is a mathematical abstraction that defines the allowable relative motion between two rigid bodies. Examples of these rigid bodies and hinge connections are described below.

One or more of the bodies, called base bodies 172, have special status in that their kinematics are referenced directly to a reference point on ground 174. The system graph is one or more “trees”. An important property of a tree is that the path from any body to any other body is unique, i.e., the graph contains no loops. The bodies in the tree are n in number (the base has the label 1). The bodies in the tree are assigned a regular labeling, which means that the body labels never decrease on any path from the base body to any leaf body 176. A leaf body is one that is connected to only a single other body. A regular labeling can be achieved by assigning the label n to one of the leaf bodies 178 (there must be at least one). If this body is removed from the graph, the tree now has n−1 bodies. The label n−1 is then assigned to one of its leaf bodies 180, and the process is repeated until all the bodies have been labeled. This is also done for any remaining trees in the system.

To help maintain the relationship between the bodies, an integer function is used to record the inboard body for each body of the system. The inboard body for each base is ground and i, the parent or inboard body 182 for body k 184, is referred to as i=inb(k). Additionally, the symbol N refers to the inertial, or ground frame 174. A superscript O refers to the ground origin (0,0,0).

The symbol for the vector from one point to another contains the name of the two points. Thus, r^{PQ} is the vector from the point P to point Q. A vector representing the velocity of a point in a reference frame contains the name of the point and the reference frame: ^{N}ν^{P}. Certain symbols to be introduced later relate two reference frames. In this case, the symbol contains the name of two frames. Thus, ⁱC^{k} is the direction cosine matrix for the orientation of frame k in frame i. This symbol refers to the direction cosine matrix for a typical body in its parent frame. Thus, ⁱC^{k}(j) indicates the actual bodyj in question. The left and right superscripts do not change with the body index. This is also true for the other symbols.

An asterisk indicates the transpose: H*(k), for example. A tilde over a vector indicates a 3 by 3 skew-symmetric cross product matrix: \tilde{v}w [symbol] v×w. Eᵢ is an i by i identity matrix., and 0ᵢ is a zero vector of length i and 0ᵢ is an i by i zero matrix. particles making up the body have fixed positions relative to each other. No flexing or other relative motion is allowed. A hinge connection is a mathematical abstraction that defines the allowable relative motion between two rigid bodies. Examples of these rigid bodies and hinge connections are described below.

One or more of the bodies, called base bodies 172, have special status in that their kinematics are referenced directly to a reference point on ground 174. The system graph is one or more “trees”. An important property of a tree is that the path from any body to any other body is unique, i.e., the graph contains no loops. The bodies in the tree are n in number (the base has the label 1). The bodies in the tree are assigned a regular labeling, which means that the body labels never decrease on any path from the base body to any leaf body 176. A leaf body is one that is connected to only a single other body. A regular labeling can be achieved by assigning the label n to one of the leaf bodies 178 (there must be at least one). If this body is removed from the graph, the tree now has n−1 bodies. The label n−1 is then assigned to one of its leaf bodies 180, and the process is repeated until all the bodies have been labeled. This is also done for any remaining trees in the system.

To help maintain the relationship between the bodies, an integer function is used to record the inboard body for each body of the system. The inboard body for each base is ground and i, the parent or inboard body 182 for body k 184, is referred to as i=inb(k). Additionally, the symbol N refers to the inertial, or ground frame 174. A superscript O refers to the ground origin (0,0,0).

The symbol for the vector from one point to another contains the name of the two points. Thus, r^{PQ} is the vector from the point P to point Q. A vector representing the velocity of a point in a reference frame contains the name of the point and the reference frame: ^{N}ν^{P}. Certain symbols to be introduced later relate two reference frames. In this case, the symbol contains the name of two frames. Thus, ⁱC^{k} is the direction cosine matrix for the orientation of frame k in frame i. This symbol refers to the direction cosine matrix for a typical body in its parent frame. Thus, ⁱC^{k} (j) indicates the actual body j in question. The left and right superscripts do not change with the body index. This is also true for the other symbols.

An asterisk indicates the transpose: H*(k), for example. A tilde over a vector indicates a 3 by 3 skew-symmetric cross product matrix: \tilde{v}w [symbol] v×w. Eᵢ is an i by i identity matrix., and 0ᵢ is a zero vector of length i and 0ᵢ is an i by i zero matrix.

Rigid Bodies of the Model

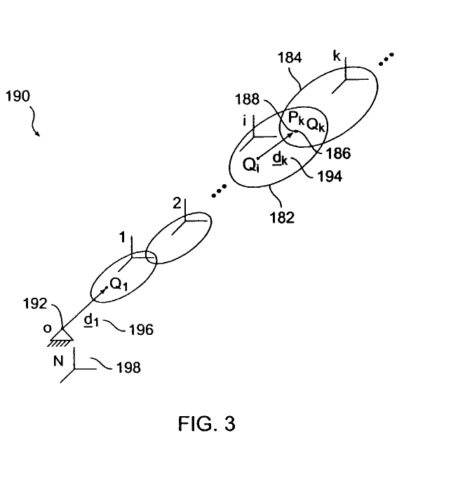

FIG. 3 illustrates the reference configuration 190 of a sample “tree” of the MBS. More than one tree is allowed. A point of each body is designated as Q, its hinge point. For example point Qₖ 186 is the hinge point for body k 184. A fixed set of coordinate axes is established in the inertial frame 198. An arbitrary configuration of the MBS is chosen as its reference configuration 190. While in this configuration the image of the inertial coordinate axes is used to establish a set of body-fixed axes in each body. In the reference configuration each hinge point Q is coincident with P, a point of its parent body (or extended body.) For each body, point P is called the body's inboard hinge point. So, the inboard hinge point Pₖ 188 for body k 184 is a point fixed in its parent body i 182. The inboard hinge point for each base body is a point O 192 fixed in ground. The expanded view that was shown in FIG. 2 more clearly shows that point Qₖ 186 is fixed in body k 184 and point Pₖ 188 is fixed in parent body i 182.

The hinge point locations define d(k) 194, a constant vector for each body, and can also be written r^{Q}^{ₗ}^{P}^{ₖ}. The vector for body k is fixed in its parent body i. It spans from the hinge point for body i to the inboard hinge point for body k. The vector d(l) 196 spans from the inertial origin to the first base body's inboard hinge point (also a point fixed in ground), and can be written r^{OQ}^{ₗ}.

For a body, m(k), p(k), and I_{Q}_{ₖ}(k) define the mass properties of body k for its hinge point Qₖ. These are, respectively, the mass, first mass moment, and inertia matrix of the body for its hinge point in the coordinate frame of the body. For a rigid body made up of a distribution of particles, the mass properties are constants that are computed by a preprocessing module. The details of these computations can be found in standard references, such as Kane, T. R., Dynamics, 3^{rd} Ed., January 1978, Stanford University, Stanford, Calif.

Let M(k), the spatial inertia of body k for its hinge point Qₖ, be given by the symmetric 6 by 6 matrix

$$M ( k ) = [ \begin{matrix}{{I}_{\underline{\_}}}_{{Q}_{k}} ( k ) & \tilde{p} ( k ) \\ - \tilde{p} ( k ) & m ( k ) {{E}_{\underline{\_}}}_{3}\end{matrix} ]$$

Each joint in the system is described by geometric data. For instance, a pin joint is characterized by an axis fixed in the two bodies connected by the joint. The particular data for a joint depends on its type. The number n, the inb function, the system mass properties, the vectors d(k), and the joint geometric data (including joint type) constitute the system parameters.

Joints and Generalized Coordinates of the Model

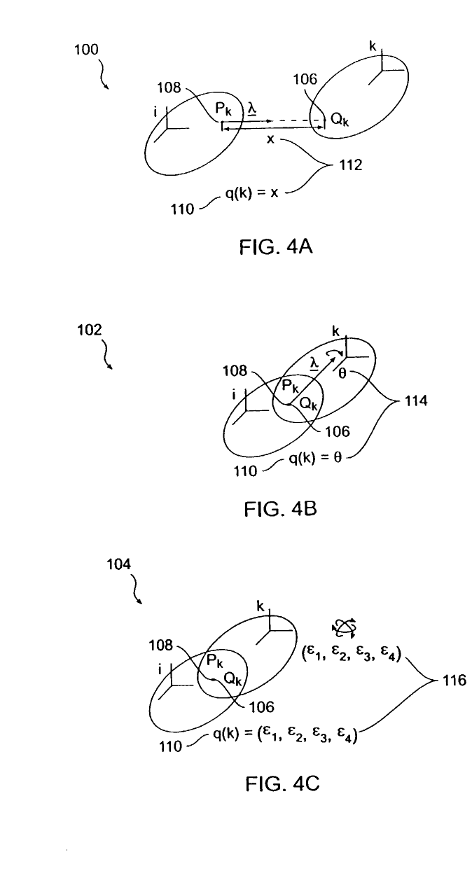

FIG. 4 illustrates the joint definitions of the preferred embodiment of the MBS: the slider joint 100, the pin joint 102, and the ball joint 104. Each joint allows translational or rotational displacement of the hinge point Qₖ 106 relative to the inboard hinge point Pₖ 108. These displacements are parameterized by q(k) 110, the generalized coordinates for body k. In passing, it should be noted that generalized coordinates are examples of generalized quantities, which refer to quantities that have both rotational character and translational character. For instance, a generalized force acting at a point consists of both a force vector and a torque vector. The generalized coordinate q(k) for the slider joint 100 is the sliding displacement x 112. The generalized coordinate q(k) for the pin joint 102 is the angular displacement θ 114. The generalized coordinate q(k) for the ball joint 104 is the Euler parameters (ε₁, ε₂, ε₃, ε₄) 116.

Each joint may be a pin, slider, or ball joint; or a combination of these joints. Many other joint types are possible through combination of these joint types, including, but not limited to free joints, U-joints, cylindrical joints, and bearing joints. For instance, q(k)=(x, y, z), the inertial measure numbers of the vector from the base body inboard hinge point to the base body hinge point express the base body displacement in ground as three orthogonal slider joints. A free joint consists of three orthogonal slider joints combined with a ball joint, and has the full 6 degrees of freedom.

The collection of generalized coordinates for all the bodies comprises the vector q, the generalized coordinates for the system.

Given the generalized coordinates for a particular joint, two quantities: r^{P}^{ₖ}^{Q}^{ₖ}(k), the joint translation vector and ⁱC^{k}(k), the direction cosine matrix for body k in its parent are formed. The translation vector r^{P}^{ₖ}^{Q}^{ₖ}(k) expresses the vector from the inboard hinge point P of body k to the hinge point Q of body k, in the coordinate frame of the parent body. Details of these computations depend on the joint type and can be easily derived. For purposes of this description, access to a function that can generate r^{P}^{ₖ}^{Q}^{ₖ}(k) and ⁱC^{k}(k) given the system generalized coordinates is assumed.

As introduced, the choice of hinge point for each body is arbitrary. However, judicious choice greatly simplifies matters. For instance, for pin joints the hinge point should be chosen as a point on the axis of the joint. For this choice points P and Q remain coincident for all values of the joint angle, so the joint translation is zero. If the point Q is chosen at a distance from the axis, points P and Q move relative to each other:

r^{P}^{ₖ}^{Q}^{ₖ}(k)=λ×r^{OQk} sin θ−(1−cos θ)(E₃−λλ*)r^{OQ}^{ₖ}

where λ is the joint axis unit vector, θ is the joint angle, and r^{OQ}^{ₖ} is the vector from any point on the axis to point Q.

For pin joints and ball joints, we will always choose a point on the axis as the hinge point. For these joints the translation vector r^{P}^{ₖ}^{Q}^{ₖ}(k) is zero.

For a slider joint the translation vector r^{P}^{ₖ}^{Q}^{ₖ}(k) is q(k)λ

The direction cosine matrix for a pin is

ⁱC^{k}(k)=E₃ cos θ+\tilde{λ} sin θ+λλ*(1−cos θ)

The direction cosine matrix for a slider is E₃.

Generalized Speeds of the Model

Let ⁱV^{k}(k), the generalized velocity of the hinge point of body k measured in its parent i, be parameterized by u(k), a set of generalized speeds. Then:

$${}_{}^{i}{V}{}_{}^{ k} ( k ) = ( \begin{matrix}{}_{}^{i}{ω}{}_{}^{ k} ( k ) \\ {}_{}^{i}{v}{}_{}^{ {Q}_{k}} ( k )\end{matrix} ) = {H}^{*} ( k ) u ( k )$$

Here, the matrix H(k) is called the joint map for this joint. It is a nᵤ(k) by 6 matrix, where nᵤ(k) is the number of degrees of freedom for the joint (I for a pin or slider, 3 for a ball, 6 for a free joint). H(k) can, in general have dependence on coordinates q. Given the generalized speeds for the joint, the joint map generates the joint linear and angular velocity, expressed in the child body frame. For the joints we use:

$$H ( k ) = [ \begin{matrix}\underline{λ} & 0 & 0 & 0\end{matrix} ] , p in$$

$$H ( k ) = [ \begin{matrix}0 & 0 & 0 & \underline{λ}\end{matrix} ] , s l i d e r$$

$$H ( k ) = [ \begin{matrix}{{E}_{\underline{\_}}}_{3} & {{0}_{\underline{\_}}}_{3}\end{matrix} ] , b a l l$$

$$H ( k ) = [ \begin{matrix}{{E}_{\underline{\_}}}_{3} & {{0}_{\underline{\_}}}_{3} \\ {{0}_{\underline{\_}}}_{3} & {}_{}^{i}{C}{}_{}^{ k} ( k )\end{matrix} ] , f r e e$$

The collection of generalized speeds for all the bodies comprises the vector u, the generalized coordinates for the system. As before, access to a function that can generate the vector ⁱV^{k}(k) given (q, u) and a specific joint type, is assumed. Access to a function that can compute the derivatives \dot{q}(k)=\dot{q}(q(k),u(k)) is also assumed. This routine generates the time derivative of the generalized position coordinates:

\dot{q}=W(q)u

where W(q) is a block diagonal matrix that relates q and u, with each block depending upon the joint type:

\dot{g}=u for pin joint, slider joint

$$[ \begin{matrix}{\dot{ϵ}}_{1} \\ {\dot{ϵ}}_{2} \\ {\dot{ϵ}}_{3} \\ {\dot{ϵ}}_{4}\end{matrix} ] = \frac{1}{2} [ \begin{matrix}{ϵ}_{4} & - {ϵ}_{3} & {ϵ}_{2} \\ {ϵ}_{3} & {ϵ}_{4} & - {ϵ}_{1} \\ - {ϵ}_{2} & {ϵ}_{1} & {ϵ}_{4} \\ - {ϵ}_{1} & - {ϵ}_{2} & {ϵ}_{4}\end{matrix} ] [ \begin{matrix}{ω}_{1} \\ {ω}_{2} \\ {ω}_{3}\end{matrix} ] for ball joint$$

where q=[ε₁ ε₂ ε₃ ε₄] and u=[ω₁ ω₂ ω₃]*

and a free joint is a combination of 3 slider joints and one ball joint. Note that there are 4 \dot{q}'s (derivatives of the Euler parameters) associated with 3 u 's for ball joints.

Similarly, ₗA^{k}(k), the generalized acceleration of the hinge point of body k in its parent, is given by:

$${}_{}^{i}{A}{}_{}^{ k} ( k ) = ( \begin{matrix}{}_{}^{i}{α}{}_{}^{ k} ( k ) \\ {}_{}^{i}{a}{}_{}^{ {Q}_{k}} ( k )\end{matrix} ) = {H}^{*} ( k ) \dot{u} ( k )$$

It is these generalized coordinates q, and generalized speeds u, the internal coordinates for purposes of this description, of the molecular system which are calculated. Rather than working with the typical inertial coordinates (x, y, z) and speeds in these inertial coordinate systems, calculations for the subject molecular system are reduced.

First Kinematics Calculations

Given the internal coordinates of the molecular system, (q, u, \dot{u}) and the system parameters, the following position, velocity and acceleration kinematics are computed for each body k.

For each body k compute:

^{N}C^{k}(k), r^{Q}^{ₗ}^{Q}^{ₖ}(k), r^{OQ}^{ₖ}(k), ⁱφ^{k}(k),

^{N}ω^{k}(k), ^{N}ν^{Q}^{ₖ}(k), V(k),

^{N}α^{k}(k), ^{N}α^{Q}^{ₖ}(k), A(k)

These computations are done recursively, starting from each base body and progressing to the leaves.

^{N}C^{k}(k), the direction cosine matrix for body k in ground is defined as:

^{N}C^{k}(l)=^{l}C^{k}(l)

^{N}C^{k}(k)=^{N}C^{k}(i)ⁱC^{k}(k), k=2, . . . n, i=inb(k)

ⁱC^{k}(k) comes from the joint routine described above.

r^{Q}^{ₗ}^{Q}^{ₖ}(k), the position vector from Qᵢ, the hinge point of the parent of body k to Qₖ, the hinge point of body k, expressed in the parent frame, is defined as:

r^{Q}^{ₗ}^{Q}^{ₖ}(k)=d(k)+r^{P}^{ₗ}^{Q}^{ₖ}(k), k=1, . . . n

r^{P}^{ₗ}^{Q}^{ₖ}(k) comes from the joint routine.

r^{OQ}^{ₖ}(k), the position vector from the inertial origin O to Qₖ, the hinge point of body k, expressed in the global frame, is defined

r^{OQ}^{ₖ}(l)=r^{Q}^{ₗ}^{Q}^{ₖ}(l)

r^{OQ}^{ₖ}(k)=r^{OQ}^{ₖ}(i)+^{N}C^{k}(i)r^{Q}^{ₗ}^{Q}^{ₖ}(k), k=2, . . . n, i=inb(k)

ⁱφ^{k}(k), the rigid body transformation operator for body k is defined

$${}_{}^{i}{φ}{}_{}^{ k} ( k ) = ( \begin{matrix}{}_{}^{i}{C}{}_{}^{ k} ( k ) & {\tilde{r}}^{{Q}_{i} {Q}_{k}} ( k ) {}_{}^{i}{C}{}_{}^{ k} ( k ) \\ {{0}_{\underline{\_}}}_{3} & {}_{}^{i}{C}{}_{}^{ k} ( k )\end{matrix} ) , k = 1 , … n$$

V(k), the spatial velocity for body k at its hinge point, expressed in the frame of body k, is defined

$$V ( 1 ) {=}^{Δ} ( \begin{matrix}{}_{}^{N}{ω}{}_{}^{ k} ( 1 ) \\ {}_{}^{N}{v}{}_{}^{ {Q}_{k}} ( 1 )\end{matrix} ) = {}_{}^{i}{V}{}_{}^{ k} ( 1 )$$

$$V ( k ) {=}^{Δ} ( \begin{matrix}{}_{}^{N}{ω}{}_{}^{ k} ( k ) \\ {}_{}^{N}{v}{}_{}^{ {Q}_{k}} ( k )\end{matrix} ) = {}_{}^{i}{φ}{}_{}^{ {k}^{*}} ( k ) V ( i ) + {}_{}^{i}{V}{}_{}^{ k} ( k ) , \\ k = 2 , … n , i = i n b ( k )$$

A(k), the spatial acceleration for body k at its hinge point, expressed in the frame of body k, is defined

$$A ( 1 ) {=}^{Δ} ( \begin{matrix}{}_{}^{N}{α}{}_{}^{ k} ( 1 ) \\ {}_{}^{N}{a}{}_{}^{ {Q}_{k}} ( 1 )\end{matrix} ) = {}_{}^{i}{A}{}_{}^{ k} ( 1 )$$

$$A ( k ) {=}^{Δ} ( \begin{matrix}{}_{}^{N}{α}{}_{}^{ k} ( k ) \\ {}_{}^{N}{a}{}_{}^{ {Q}_{k}} ( k )\end{matrix} ) = \overline{A} + ( \begin{matrix}\tilde{ω} & {{0}_{\underline{\_}}}_{3} \\ {{0}_{\underline{\_}}}_{3} & 2 \tilde{ω}\end{matrix} ) {}_{}^{ i}{V}{}_{}^{ k} ( k ) + {}_{}^{i}{A}{}_{}^{ k} ( k ) , \\ k = 2 , … n , i = i n b ( k )$$

$$where$$

$$\overline{A} = {}_{}^{i}{φ}{}_{}^{ {k}^{*}} ( k ) A ( i ) + ( \begin{matrix}{{0}_{\underline{\_}}}_{3} \\ {}_{}^{i}{C}{}_{}^{ {k}^{*}} ( k ) ( {}_{}^{N}{ω}{}_{}^{ k} ( i ) \times {}_{}^{N}{ω}{}_{}^{ k} ( i ) \times {r}^{{Q}_{i} {Q}_{k}} ( k ) )\end{matrix} )$$

$$ω = {}_{}^{i}{C}{}_{}^{ {k}^{*}} ( k ) {}_{}^{N}{ω}{}_{}^{ k} ( i )$$

Of course, the computations can all be computed in a single pass if desired.

After completing these steps for one incremental time step, the MBS can service kinematics requests to compute (generalized) position, velocity, or acceleration information for any point of any body. This is done by computing the required information for any point in terms of the hinge quantities for its body, using standard rigid body formulas.

Dynamic Residual Step

Starting with a given state of the molecular model, i.e., given (q, u, \dot{u}) and the system parameters, a program routine models the ‘environment’ of the MBS. Such routines are readily available to, or can be created by, practitioners in the computer modeling field. The routine takes the values (q, u) determined by and passed in from the integration submodules 68 and returns (the state-dependent)

$$T ( k ) = ( \begin{matrix}{T}_{{Q}_{k}} ( k ) \\ F ( k )\end{matrix} ) ,$$

the applied spatial force for a body k at its hinge point Qₖ, and σ(k), the hinge torque for the body k. T(k) and σ(k) are computed in the Physical Model module 54 based on the Force Field module 62 and the Solvent module 64 in the Biochem Components module 52 shown in FIG. 1. The dynamics residual, ρ,ᵤ(k), associated with generalized speeds u(k) for the body k is then computed by the following steps:

1. Generate \hat{T}(k), the spatial load balance for each body

$$\hat{T} ( k ) = M ( k ) A ( k ) + ( \begin{matrix}{}_{}^{N}{\tilde{ω}}{}_{}^{ k} ( k ) ( {{{I}_{\underline{\_}}}_{{Q}_{k}} ( k )}^{N} {ω}^{k} ( k ) ) \\ {}_{}^{N}{\tilde{ω}}{}_{}^{ k} ( k ) ( {}_{}^{N}{ω}{}_{}^{ k} ( k ) \times p ( k ) )\end{matrix} ) - T ( k )$$

$$k = 1 , … n$$

2. Compute ρᵤ(k)

for k=n to 2 by −1

ρᵤ(k)=H(k)\hat{T}(k)−σ(k)

i=inb(k)

\hat{T}(i)+=ⁱφ^{k}(k)\hat{T}(k)

end

ρᵤ(l)=H(l)\hat{T}(l)

The dynamics residual, ρᵤ(k), appears because the Residual Form (in contrast to the Direct Form) of the equations of motion for the model. A detailed description of the Residual Form and Direct Form of differential equations and their integration is found in the above-referenced co-pending U.S. patent application Ser. No. ______, entitled “METHOD FOR RESIDUAL FORM IN MOLECULAR MODELING,” filed of even date.

Second Kinematics Calculations

Compute: P(k), D(k), ⁱψ^{k}(k), ⁱK^{k}(k):

1. Initialize P(k), the articulated body inertia of each body.

P(k)=M(k), k=1, . . . , n

2. Generate objects

for k=n to 2 by −1

D(k)=H(k)P(k)H*(k)

G=P(k)H*(k)D⁻¹(k)

\overline{τ}=E₆−GH(k)

iψ^{k}(k)=^{l}φ^{k}(k)\overline{τ}

ⁱK^{k}(k)=ⁱφ^{k}(k)G

i=inb(k)

P(i)+=ⁱψ^{k}(k)P(k)ⁱψ^{k*}(^{k})

end

D(l)=H(l)P(l)H*(l)

The functional dependence of these quantities is only upon q.

Forward Dynamics Calculations

Compute: \dot{u}:

z(k)=0₆, k=1, . . . n

for k=n to 2 by −1

ε(k)=ρᵤ(k)−H(k)z(k)

ν(k)=D⁻¹(k)ε(k)

i=inb(k)

z(i)+=ⁱψ^{k}(k)z(k)+ⁱK^{k}(k)ρᵤ(k)

end

ε(l)=ρᵤ(l)−H(l)z(l)

ν(l)=D⁻¹(l)ε(l)

\dot{u}(l)=ν(l)

δ(l)=H*(l)ν(l)

for k=2 to n

i=inb(k)

δ(k)=ⁱψ^{k*}(k)δ(i)+H*(k)ν(k)

\dot{u}(k)=ν(k)−ⁱK^{k*}(k)δ(i)

end

Direct Form Method

The Direct Form method takes the current state (q, u) and computes the derivatives (\dot{q}, \dot{u}) using the above algorithms, which are then used by the integration method to advance time. Starting with the state (q, u), compute (\dot{q}, \dot{u}):

1. Compute \dot{q} using joint specific routines above

2. Perform above First Kinematics Calculations with \dot{u}=0

3. Generate residuals ρᵤ using the Dynamic Residual Calculations, and negate

ρᵤ=−ρᵤ

4. Perform Second Kinematics Calculations

5. Perform Forward Dynamics Calculations to compute \dot{u}

The Direct Form method produces the hinge accelerations \dot{u} in response to the applied forces acting on the system. Now (\dot{q}, \dot{u}) is passed to a numerical method to integrate the equations of motion of the molecular model.

Numerical Method to Integrate Equations of Motion of Molecular Model

As explained previously, efforts to model molecular systems have heretofore required inordinate amounts of computer power and time. Even with a carefully chosen molecular model and the use of internal coordinates, as described above, the equations of motion must be integrated. Heretofore, these efforts have centered about the integration in small time steps of the differential equations used to define the molecular systems. However, a straightforward requirement of integrating the differential equations in large timesteps does not solve the complex problems of molecular modeling. A more reasoned approach is required.

Solving Stiff MD Simulations

When attempting to numerically integrate a system of ordinary differential equations (ODE's) or differential algebraic equations (DAE's) posed as an initial value problem, the largest timestep can be limited by the accuracy of the solution desired or by the stability of the integration method used. If the timestep when using an explicit integration method is limited solely by the accuracy of the solution desired, then the system under study is considered “non-stiff.” However, if the integration method tends to “blow-up” or becomes unstable at timesteps much smaller than might be expected for the system under study, then the term “stiff” is used to describe the situation, i.e., the largest timestep is limited by the stability of the particular integration method.

The present invention is directed toward the molecular modeling of systems in which undamped high frequencies (and hence accurate solutions at very small time scales) are of no interest and which do not affect the long time-scale solution of the modeling of the molecular system. An example of the problem of so-called “stiff” systems might be the modeling of a simple pendulum that rocks back and forth with a period of one second. Now, a very small mass is attached to the end of the pendulum using a very stiff spring. The natural vibration of the small mass and spring system is, say 1000 cycles per second. That is, for each swing of the pendulum, the small mass vibrates 1000 times. Furthermore, the high frequency vibrations of the small mass are hardly noticeable because of their small amplitude, and don't affect the large scale swinging motion in any significant way for the behavior we are studying. An explicit integration method with timestep and error control is applied to solve the model of the swinging pendulum. If the integrator takes very tiny timesteps even if the high frequency vibrations are much smaller than the error tolerance, then the system is “stiff”.

A simple experiment to perform is to loosen the error tolerance by a known amount, say a factor of 10, and then re-run the same study. If the timestep sizes taken do not grow by approximately the amount expected given the order of the integrator, then the problem is stiff. Attempting to take larger times steps results in the integration method “blowing up”. This behavior is purely an artifact of the integration method. The present invention bypasses the stiffness limitations to timestep size inherent in many previous molecular modeling simulations. To attack this class of molecular modeling problems, the present invention uses “sufficiently stable” implicit integration methods for the integrator submodules 68 of FIG. 1. We will present a more rigorous definition of “sufficiently stable” below, but the error tolerance adjustment experiment above works well in practice-if the timestep sizes respond as expected to error tolerance settings, then the method is sufficiently stable for the problem at hand. Alternatively, we may choose an L-stable method since those are always sufficiently stable.

As an introduction to implicit methods, consider a simple Euler integration method. The explicit version of the Euler method for integrating the ODE \dot{y}=ƒ(y) uses a truncated Taylor Series expansion about the past solution: yₙ=yₙ₋₁+hₙƒ(yₙ₋₁), that is, the solution for yₙ for the next timestep of size hₙ depends only upon the past solution yₙ₋₁. Thus yₙ is only on the left hand side of the equation and can be solved for directly, or explicitly. In contrast, the implicit version of the Euler integration method uses a truncated Taylor Series expansion about the future solution: yₙ=yₙ₋₁+hₙƒ(yₙ), resulting in an equation with the desired answer yₙ on both sides of the equation (hence, implicit in yₙ), thus requiring a nonlinear iteration (usually some version of Newton's Method) to solve the equation g(yₙ)=yₙ−yₙ₋₁−hₙƒ(yₙ)=0. This apparently simple change in the integration technique results in a dramatic change to the stability of the method, but at the considerable cost of having to perform a nonlinear iteration step.

It is possible to determine the stability of an integration method by the examination of a stability function R(z), which can be written for any integration method. The derivations of these stability functions are straightforward, but quite involved. Details can be found in Hairer and Wanner, Solving Ordinary Differential Equations II. Stiff and Differential-Algebraic Problems, 2^{nd} ed., Springer, 1996. In accordance with the present invention, a strong form of stability known as L-stability guarantees sufficient stability for any molecular modeling problem. L-stable integration methods form a strong subclass of weaker stable integration methods, known as A-stable integration methods. In many cases A-stable or even weaker methods such as A(α)-stability, will also be sufficiently stable.

Mathematically, the stability domain of an integrator with stability function R(z) is as follows:

S={zε [symbol] C;|R(z)|≦1}

where [symbol] represents the complex plane, and z is a complex number of the form z=x+iy. The stability of a particular problem can be approximately tested by assigning z=hλ, where h is the timestep and λ=ζω+iω\sqrt{1−ζ²} is an eigenvalue of a linearized model of the system being integrated, where ω is the undamped natural frequency and ζ is the damping factor. Usually the eigenvalue λ that limits the stability of the method is the highest frequency eigenvalue of the system. In general, the higher the frequency, the smaller the timestep h that can be used before the stability limits are reached. For precise determination of sufficient stability for a particular nonlinear model undergoing large conformation changes, one must determine that all of the eigenvalues of the system when linearized about each of its conformations lie within the stability region.

From the stability domain S of the stability function, it is possible to determine if the implicit integration method is A-stable:

If S⊃ [symbol] ⁻={z; Re(z)≦0}, i.e., covers at least the entire left half of the complex plane [symbol] , then the Method is A-stable. The extent of the stability region S in the complex plane [symbol] is used to define whether the integration method is A-stable or not.

If the method is A-stable, then the method might meet the stronger test of L-stability as follows: If

$${lim}_{z \to ∞} R ( z ) = 0$$

then the Method is L-Stable and is sufficiently stable for any problem.

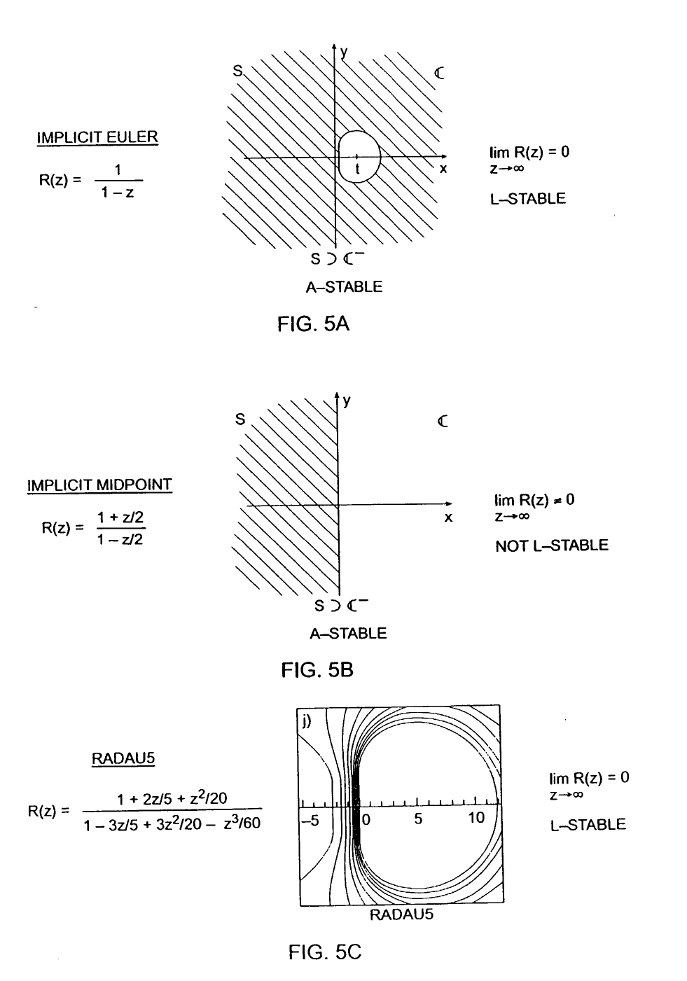

FIGS. 5A-5C illustrate the stability for various known integration methods. In these drawings, the particular integration method is given on the left with its stability function R(z), its stability region S in the complex plane [symbol] is illustrated in the middle with a determination (or not) of A-stability, and a determination of L-stability on the right.

The implicit Euler integration method, the stability of which is illustrated in FIG. 5A, is recognized as being one of the strongest L-stable integration methods due to its large stability domain and rapid damping of high frequencies in simulations. The implicit mid-point method is clearly A-stable, but is not L-stable, as shown in FIG. 5B. The Radau5 integration method is L-stable, as shown in FIG. 5C, and has the additional property of having very good control of errors in its solution. Further descriptions of the characteristics of stiffness, implicit integration solution techniques, and A-stability and L-stability can be found in Hairer, cited previously, and U. Ascher, Computer Methods for Ordinary Differential Equations and Differential-Algebraic Equations, SLAM, Philadelphia, Pa., 1998.

Interestingly, a common integrator used in molecular dynamics simulations, the Verlet method, is an explicit method and possesses neither A-stability nor L-stability. The stability “interval” for this method is approximately given by (Lopez-Marcos, An explicit symplectic integrator with maximal stability interval, Report of the Department of Applied Mathematics, Universidad de Valladolid, Spain, 1995):

h<L

where L=2/ω for MD equations cast in the form ÿ=ƒ(y), and ω is the highest frequency eigenvalue of a linearized model. For most MD simulations, the high frequency of the molecular bond vibrations limits h to less than about 1 to 2 femtoseconds. Locking out the highest frequency bond vibrations using SHAKE or RATTLE improves the situation a bit and allows up to approximately 10 femtosecond timesteps. However, the stability problem remains.

The present invention offers a significant advance in at least two fields of molecular modeling in which progress has been slow. The first field is that of “static analysis”, which addresses the problem of determining a local energy minimum beginning from a given configuration. This can be used to solve the subproblems encountered while searching for a global minimum. That is, given the chemical composition of a complex molecule, for example, what is the molecule's stable, minimum energy configuration? An example of molecular systems for which such solutions would be extremely useful is the final, or intermediate, folded configurations of proteins. The second field for which the present invention is immediately useful is that of molecular dynamics, sometimes termed MD, in which the time history of molecular system is desired. Given the initial conditions for a molecular system, molecular dynamics examines the changes of the system in time. For example, the dynamic interactions of a drug ligand with the binding pocket of a protein could be determined.

Static Analysis

Static analysis is used to determine the minimum energy configurations of the molecular system under study. Important minimum energy configurations may be local minima or the global minimum, and often represent the functional configurations for the systems, such as the operational configuration for an enzyme or other folded protein.

The preferred embodiment for static analysis is to apply to a reduced-coordinate molecular model an L-stable integrator that absorbs the most energy from the system, and takes the largest timesteps possible to reach the stable configuration. The implicit Euler (IE) integration method applied to a rigid body and torsion angle reduced model is the preferred embodiment for static analysis in accordance with the present invention. Being a simple first-order method, the implicit Euler method produces large errors that lead to large energy absorption at each time step. The stability region is one of the largest known, thus allowing very large timesteps. The timesteps are generally only limited by the ability for solution of the nonlinear system to converge. Since it is the minimum energy configurations which are sought, and not the particular behavior of the molecular system in time, the large errors produced by the method do not hinder the accuracy of the results. A second possible embodiment is Radau5 with its error control disabled.

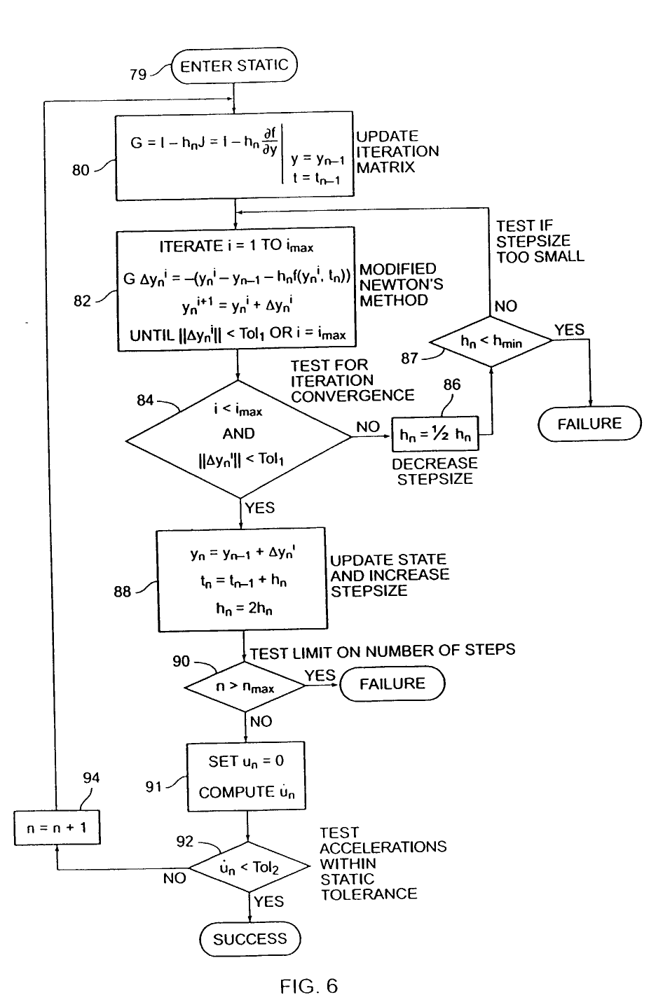

The implicit Euler integration method is illustrated in the flow chart of FIG. 6 for the vector function \dot{y}=ƒ(y, t) (where y=(q, u), q representing the position states and u the velocity states of the molecular system). The function ƒ includes both the multibody system dynamics and the forces such as electrostatic attraction and repulsion, van der Waal's forces, and salvation forces. After an entry step 79, the first operation step 80 updates the Iteration matrix G. For all implicit integration methods, the Iteration matrix G has the form G=I−αJ, where I is the identity matrix, α is some scalar function of the timestep hₙ, the timestep between time tₙ and tₙ₋₁, and J, the Jacobian given by

$$J {=}^{Δ} \frac{\partial f}{\partial y} .$$

For the implicit Euler method, α=hₙ. In passing, for additional savings in computer time, it should be noted that a very efficient method of computing Jacobian matrices from the residual form of equations is covered in previously cited co-pending U.S. patent application Ser. No. ______, entitled “METHOD FOR ANALYTICAL JACOBIAN COMPUTATION IN MOLECULAR MODELING,” filed of even date and is assigned to the present assignee. As in the case of the present invention, the same referenced patent application also describes the use of internal coordinates to describe the state of the molecular system. For example, the rotation of one part of the molecule is described with respect to another part, rather than with respect to an external referenced coordinates. This further increases computing efficiency.

A sequence 82 of steps in accordance with a modified Newton's iteration method (See Ascher, op. cit. for a description of Newton's method) iteratively finds the position states and velocity states of the molecular system at time tₙ. The state y is representative of all the position states and velocity states. The iteration to find yₙ ends when either the change in y is within a tolerance Tol₁ or a maximum number of iterations allowed iₘₐₓ is reached. The tolerance Tol₁ and maximum number of iterations iₘₐₓ are adjusted experimentally to maximize overall performance. Typical values are Tol₁=10⁻⁴ and iₘₐₓ=10.

The symbols ∥ ∥ represent taking the 2-Norm of the vector. It should be noted that rather than inverting the Iteration matrix G to solve for Δyₙⁱ, it is customary to use more stable linear solution techniques, such as LU Factorization, a well-known technique in numerical analysis. Step 84 tests for convergence. If convergence is met, then the state y and time t are updated and the timestep hₙ is increased as indicated by the step 88. Otherwise, the timestep hₙ is reduced by step 86 and the sequence 82 of the modified Newton's iteration method is attempted again. The static analysis will fail if the timestep is too small in test step 87. It should be noted that doubling of the time interval in the step 88 or halving in the step 86 are simple examples of how the time integration intervals are varied. Often more sophisticated algorithms are used in publicly available integration methods.

After the state y and time interval are updated, a decision step 90 tests for whether the maximum allowable number of steps has been performed. If the maximum number of steps nₘₐₓ has been taken, then the static analysis has failed. Otherwise, the velocities uₙ in the state yₙ are set to zero in step 91 and the accelerations \dot{u}ₙ are tested in step 92 to see if they are smaller than the acceptable tolerance Tol₂. If so, the static analysis has succeeded. Otherwise, the step is incremented in step 94 and the process returns to step 80 to update the Iteration matrix and so forth. Typical values are Tol₂=10⁻⁵ and nₘₐₓ=500.

Molecular Dynamics

Another goal of molecular modeling is molecular dynamics, simulations to determine accurately the time history of a physical process in a molecular system, such as the folding of a protein or the docking of a ligand with an active site in a protein.

In accordance with the present invention, the ODE's which model the molecular system in question are integrated in time by sufficiently stable integration methods with error control. A higher order (at least order 2) sufficiently stable integrator with error control provides the required accuracy, while rapidly damping the irrelevant high frequencies in the model. The largest possible timesteps are taken to achieve a desired accuracy; integration is not limited by stability problems. A trade-off can be made between accuracy and computing time without limitations to the size of the timesteps due to the stability of the integration.

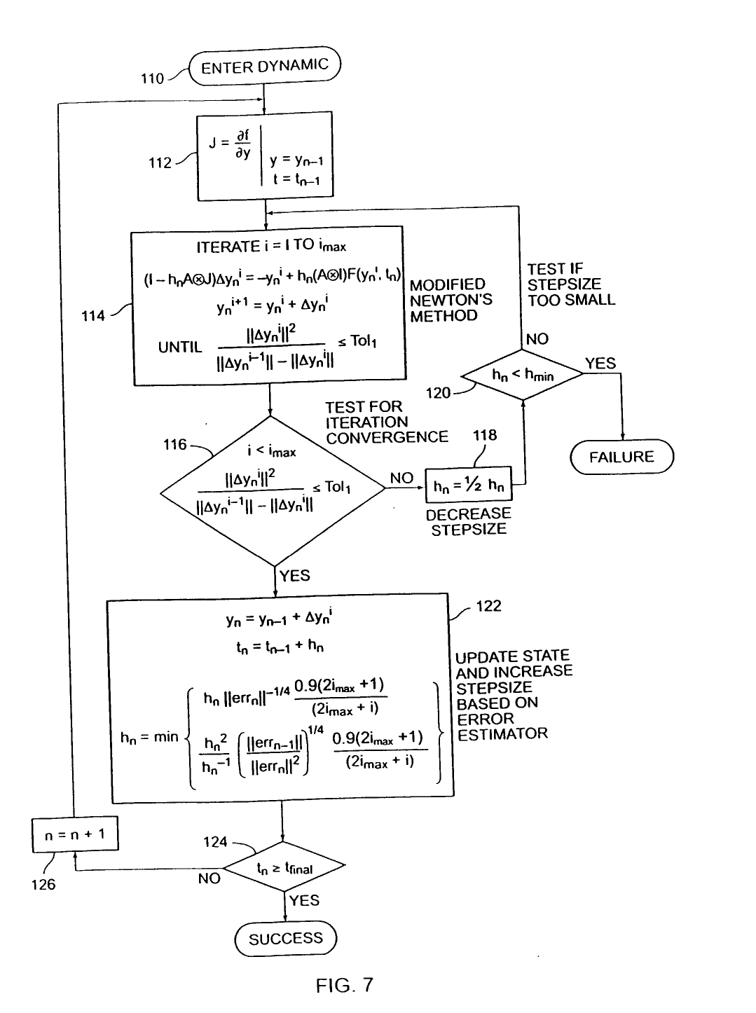

A preferred embodiment is the implicit Radau5 integration method, specifically, an implicit Runge-Kutta integrator of Type Radau IIA, order 5. See Hairer, pp.118-127, referenced previously. Radau5 is L-stable and hence sufficiently stable for all models and circumstances. A flow chart overview of the implementation of this integration method is shown in FIG. 7. The Radau5 method is a single-step implicit integrator with three stages. Thus, it has a similar structure as the implicit Euler shown in FIG. 3, but has three stages, instead of one, and incorporates several methods, including complex algebra and matrix transforms, to reduce operation count and round-off errors. The Radau5 method also has an error estimator for regulating timestep size in accordance with a user-specified accuracy requirement.

After the entry step 110, the Jacobian matrix J is updated in step 112. As in the implicit Euler method, a modified Newton's iteration is performed in step 114 with the Iteration matrix G=I−hₙA [symbol] J and residual function r(yₙ^{l})=yₙⁱ−hₙ(A [symbol] I)F(yⁿⁱ, tₙ) contain matrix A and matrix function F which expand the three stages of the Radau5 method. The symbol [symbol] means tensor product. See Hairer, op. cit., for detailed description of the terms shown, as well as the error estimator terms explained below.

Convergence of the Iteration matrix is tested in step 116. If the iteration does not meet tolerance Tol₁ within the maximum number of iterations iₘₐₓ, then the stepsize hₙ is decreased in step 118 and the iteration is attempted again, unless the minimum stepsize hₘᵢₙ is reached in test step 120 and the analysis fails. Typical values are provided in Hairer.

Once the iteration is accepted, the state is updated in step 122 and a new stepsize hₙ is computed based on the error estimation err which is a function of various absolute and relative tolerances, as explained in Hairer. If the final time t_{final} has been reached in test 124, the dynamic analysis is successfully completed. Other conditions can also be tested for termination instead of, or in addition to, reaching t_{final}. Otherwise, the step n is incremented by step 126 and the loop continues. In practice, conditions other than reaching t_{final} may be used to indicate completion, for example reaching a prescribed level of kinetic or potential energy.

Application Examples of the Present Invention

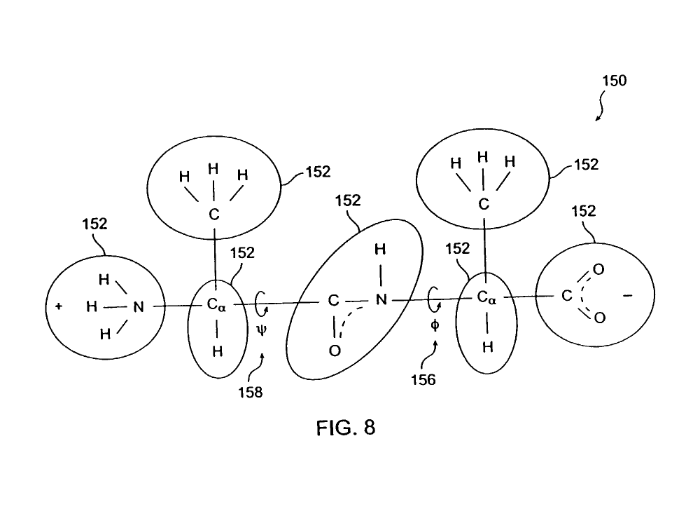

To illustrate the advantages of the present invention, the implicit Euler integration method, the Radau5 integration method, and a prior art Verlet integration method were applied by us to a molecular simulation problem. FIG. 8 illustrates the structure of the protein fragment with two residues, alanine dipeptide 150, for which stable, or “static”, minimum energy configurations are known to exist. Alanine dipeptide has the amino acid formula of Ala-Ala, and the chemical formula of NH₃⁺—CH—CaH—CH₃—CONH—CaH—CH₃—COO⁻ where C_{α} are the alpha carbons in each residue and CONH is the rigid peptide bond 154 between each residue. The multibody description contains seven bodies 152 with several atoms per body. Each body consists of one or more atoms that are considered as rigidly bound together. The 7 bodies represent a total of 23 atoms. The connections between the rigid bodies are covalent bonds represented as pin joints that allow the bodies to rotate with respect to each other. Two of the pin joints on either side of the peptide bond 154 are represented by the configuration angles, φ 156 and ψ 158. This model of alanine dipeptide has a possible minimum energy configuration with φφ≈147° and ψ≈162°.

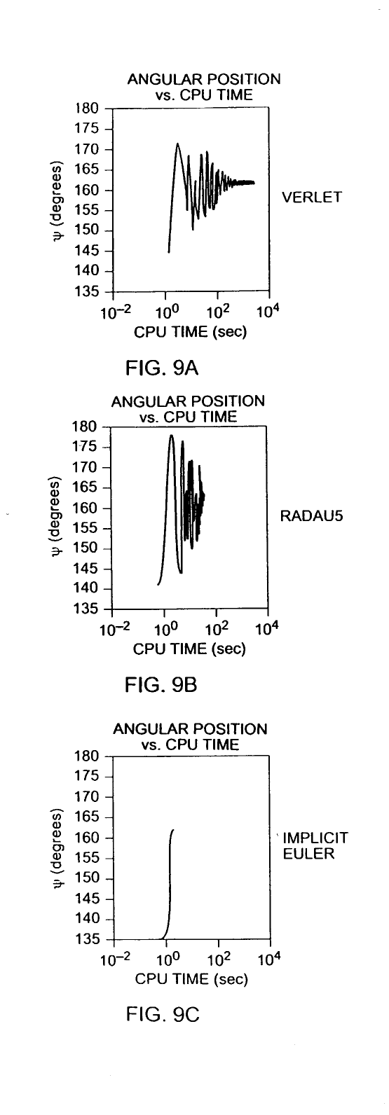

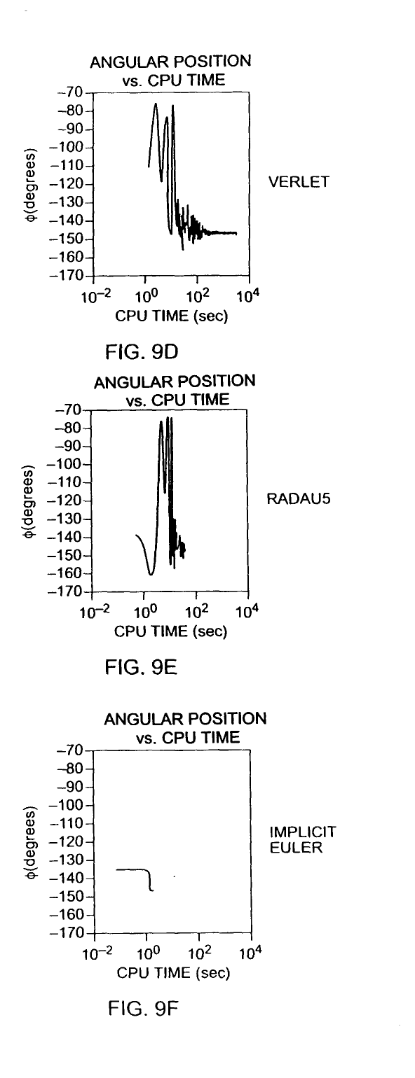

The graphs in FIGS. 9A-9F illustrate the results of the three integration methods. FIGS. 9A-9C show the results for the configuration angle ψ for the Verlet, Radau5 and implicit Euler integration methods respectively, and all have identical axes for comparison purposes. The vertical axes are in degrees. Similarly, FIGS. 9D-9F, show the results for the configuration angle φ for the three methods, and all also have identical axes for comparison purposes. The vertical axes are in degrees. The horizontal axes are logarithmic scale in CPU time (seconds on a personal computer with an 800 MHz Pentium III microprocessor) to compare the time required to complete each simulation. All three simulations were started with the same initial conditions for the configuration angles: ψ=135° and φ=−135°, and ended with approximately the same results.

The standard Verlet integration method required approximately 2,900 seconds to solve the problem, while the implicit Euler required only about 2.5 seconds, a factor of over 1000 times faster on the same computer. It should be noted that the implicit Euler solutions are much smoother and do not track the unneeded high-frequency components of the alanine dipeptide molecular system that the Verlet integration method showed. As might be expected, the final correct solution is independent of the high-frequency components.

The Radau5 integration method required 40 seconds, a factor over 70 times faster than the Verlet method. The implicit Radau5 solutions were “noisy” and did track important behavior, but not the unnecessary high-frequency components of the protein fragment that the Verlet method showed. As might be expected, the final solution was independent of the unnecessary high-frequency components.

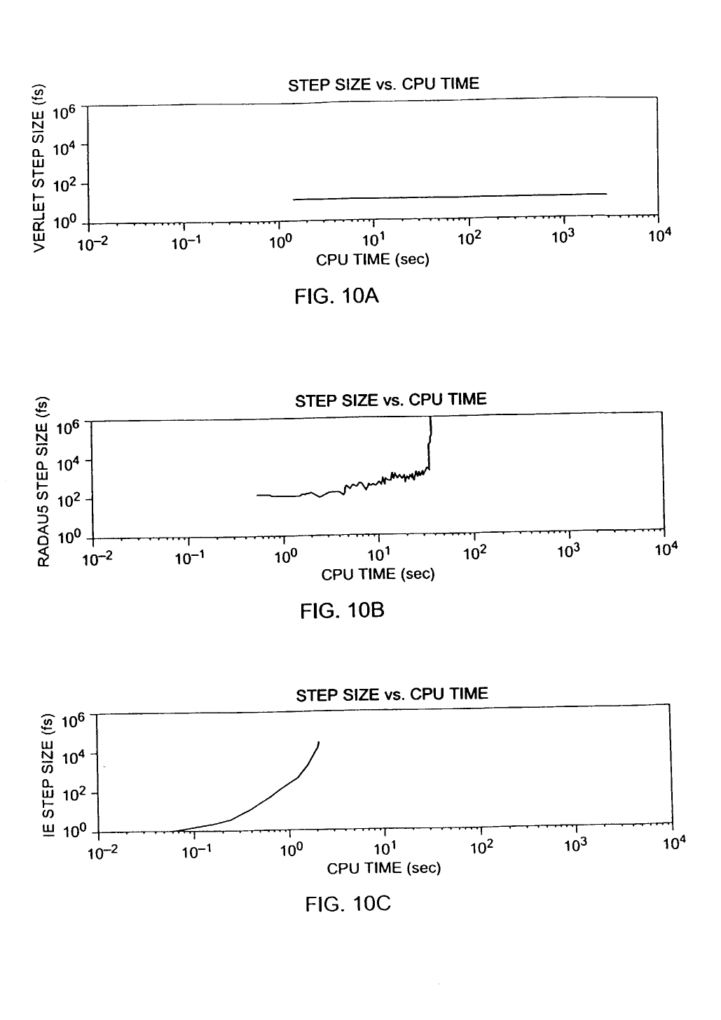

FIGS. 10A-10C illustrate the step size (femtoseconds) vs. CPU time (seconds) for each of the three simulations discussed in FIGS. 9A-9F. It should be noted that in the FIGS. 10A-10C graphs, both axes are logarithmic scale. FIG. 10A shows the constant 10 femtosecond timestep that could be achieved by the explicit Verlet integrator. FIG. 10B shows the Radau5 stepsize increasing from approximately 100 femtoseconds at the beginning of the simulation to 10⁸ femtoseconds (or 100 nanoseconds!). FIG. 1C shows the implicit Euler stepsize increasing from approximately 1 femtoseconds at the beginning of the simulation to 10⁴ femtoseconds. These large stepsizes are unheard of in prior art MD simulations.

Sufficiently stable integration methods, such as L-stable methods, can be applied to any form of reduced coordinate molecular model and used to solve problems in molecular modeling in accordance with the present invention. Such models include, but are not limited to:

1) Constrained models of molecules with closed loops and other algebraic constraints, as well as open tree structures;

2) Other reduced formulations of the molecular models, besides the torsion angle dynamics model described above, such as substructured models;

3) Residual Form of the Ordinary Differential Equations or Differential Algebraic Equations, as well as the Direct Form;

4) The use of full Newton's method and other iteration techniques, as well as modified Newton's method for the iteration technique used to solve the nonlinear equations;

5) The use of numerically derived as well as analytically derived Jacobians;

6) The use of partially all-atom models, rigid-body models, flexible-body models, combinations thereof, or any other representation of atomic structure of the molecule;

7) The use of combinations of reduced coordinate models with all-atom models such as water or other explicit solvents, drugs, and other small molecules;

8) The use of various methods for adjusting timestep size, including but not limited to the methods shown in the preferred embodiments; and

9) In addition to Radau5 and implicit Euler L-stable integrators, other L-stable implicit integrators with or without error control including, but not limited to, the SDIRK, SIRK, and Rosenbrock families of integrators;

10) Other sufficiently stable methods, including, but not limited to, DASSL and other multistep methods for ODEs or Differential Algebraic Equations (DAEs).

With sufficiently stable integrators with appropriately reduced molecular models in accordance with the present invention, the speed with which accurate molecular modeling can be performed on a computer is dramatically improved and the invention's benefits are manifest. In particular, the invention is very useful when applied to the folding of proteins because these are large-scale reactions that take a very long time to complete—typically, on the order of microseconds to seconds in nature. Current approaches to molecular dynamics run far too slowly to simulate more than a few nanoseconds of a protein folding operation for all but the smallest proteins. The present invention provides a highly significant tool for solving the problems of protein folding for determining the structure of proteins. Proteins whose structures cannot be determined with current computational or experimental techniques, such as membrane-bound proteins, can be tackled with the current invention. The enormous time and costs for empirically determining the structures of the million or so known proteins are avoided. The present invention bolsters rational drug and protein design since the native structure of proteins can be quickly determined and their interactions with drugs and other proteins simulated. Research into the folding pathways, structure, and function of proteins is significantly enhanced.

The present invention could be used to simulate many other biomolecules such as RNA, DNA, polysaccharides, and lipids. Also, molecular structures of combinations of these biomolecules such as protein-RNA complexes such as ribosomes and protein-DNA complexes such as histones and DNA in chromatin could be simulated. Processes which modify the structure of proteins could be simulated, such as the post translational modifications of proteins by chaperon proteins.

Further Applications

The present invention can be used as a core computation in many algorithms pertaining to computational molecular modeling. For example, an algorithm may choose a set of initial conditions according to some desired criteria (e.g., statistical distribution) and take one member of the set as the starting configuration of each of many separate molecular dynamics runs. Each run may be done on a separate computer as part of a massively parallel computation, or some or all may run on a single computer. The present invention is used to perform the molecular dynamics; then the results are obtained by the higher-level algorithm for further processing. Another algorithm is a simulation of a ribosome deployment or extrusion of a protein, in which the molecular model grows as amino acids are added to the protein at a physically realistic rate, or with some other chosen rate, with the present invention used to simulate the behavior and properties of each length of the developing protein. Another class of algorithms is those that mix occasional energy-increasing events with energy conserving or dissipating simulations done using the present invention. Such algorithms typically contain inputs designed to capture temperature-bath effects generated by solvent, for example Langevin terms or other energy-increasing effects designed to functionally or statistically model temperature effects.

The present invention is also useful as a core computation in algorithms that attempt to perform design or improvement of molecular systems. In these algorithms, the present invention is used to calculate properties of a particular system. These properties can be altered by a set of specified changes, or types of changes, called “design parameters” which can be made to the system as part of the design or improvement process. Information obtained about the changes to properties which occur as a result of changes to the design parameters when analyzed using the present invention are used to direct further changes to the design parameters leading to improvements in the desired properties. For example, say a protein is desired which will bind tightly to a particular ligand. Initially, the protein-ligand system is analyzed by the present invention, with the binding affinity property calculated as a result. Individual amino acids of the protein are considered design parameters. Changes to one or more amino acids are made in accordance with some algorithm, which may be random or more sophisticated. Then the binding affinity is recalculated using the present invention. The resulting change to binding affinity is used to guide further modifications to amino acids, until a sequence is discovered which yields an improvement to the desired binding affinity for the specified ligand. This new protein may be synthesized and tested against the ligand in the laboratory to verify the validity of the results and to determine the possibility that the novel protein may have medical or commercial applications.

Other design algorithms can include improvements to any parameters of the molecular model, including empirically derived force field and solvent characteristics. These algorithms may be performed on different kinds of reduced-coordinate models, such as ones in which amino acids are abstracted into simpler elements characterized by properties of interest such as charge or hydrophobicity.

When molecular structure is already known, the methods of the invention are particularly useful for screening libraries of compounds for interaction with a target as an alternative or an adjunct to conventional biochemical screening methods. A compound or subset of compounds that appears to interact with the target in a desired manner identified by the present modeling methods can then be synthesized and tested by a conventional biochemical assay. The present methods can thus reduce the number of compounds that need to be synthesized and the number of biochemical assays that would otherwise be needed to identify a compound with a desired functional property. The present invention is superior to other computer techniques for this application because it allows for conformation changes (flexibility) of both target and ligand during screening, thus greatly increasing predictive accuracy.

In accordance with the general approach described above, the methods provide a model for the interaction of a compound with a target, including equations of motion for the compound and the target. For effective use of implicit integration, the models should use reduced coordinates.

Data concerning the compounds to be screened and the target are supplied for input into the equations of motion. The data can be supplied by the user or can be obtained from stored files, remote database or from measuring instruments. In some instances, the compounds and/or target are described by chemical name. In other instances, the compounds or targets are described by component molecules (e.g., a sequence of amino acids or nucleotides). In other instances, the compounds or targets are described by component atoms and the nature of bonds holding the atoms together. In addition or alternatively, compounds and/or the target can be described by experimental data, such as X-ray patterns, infra red spectra, ultraviolet spectra or nuclear magnetic resonance spectra, or information calculated based on the same, such as distances between atoms, rotational freedom, and excitation states. In some methods, additional data are supplied, such as the identity and/or composition of a solvent or other environment, such as a phospholipid matrix, in which compounds are to interact with the target. In some methods, other environmental factors such as temperature or pressure at which compounds and target are to interact are supplied.

The equations of motion are solved to produce a model of the interaction of a compound with the target. The model can be displayed on a screen. Various parameters regarding the interaction can also be output, such as the binding affinity of a compound with the target, rate constant for association of the compound with the target, and the distance between certain atoms of the compound with certain atoms of the target. In some instances, the interaction of a compound being screened with the target is compared with those of a compound already known to interact with the target in a desired manner. Favorable interaction with the target can be assessed by strength of binding affinity, speed of binding kinetics, closeness of fit between compound and target, induction of a conformational change in the target indicative of signal transduction, proximity of certain atoms in the compound to certain atoms in the target, or by similarity of fit of compound to a control compound already known to interact in a desired manner with the target. In some methods, as in screening compounds for detergent activity, a favorable interaction is indicated by loss of specific structure of the target indicating that it is denatured by the compound being screened. In some methods, a model or data based on a model is displayed after each compound is screened. In other methods, a plurality or all of the compounds are screened, and models or data for only a subset are displayed.

The present methods can be used to screen the same or similar types of compounds to those screened in conventional methods. Such compounds includes peptides, proteins including antibodies, small molecules (kDa<=500), beta-turn mimetics, polysaccharides, phospholipids, hormones, prostaglandins, steroids, aromatic compounds, heterocyclic compounds, benzodiazepines, oligomeric N-substituted glycines and oligocarbamates. Large combinatorial libraries of the compounds can be constructed by the encoded synthetic libraries (ESL) method described in Affymax, WO 95/12608, Affymax, WO 93/06121, Columbia University, WO 94/08051, Pharmacopeia, WO 95/35503 and Scripps, WO 95/30642 (each of which is incorporated by reference for all purposes). Peptide libraries can also be generated by phage display methods. See, e.g., Devlin, WO 91/18980. Natural compounds for which structural data are available from sources such as, marine microorganisms, algae, plants, and fungi can also be screened. In some instances, the compounds to be screened include one or more compounds that have already been established by biochemical assay or otherwise to have a desired interaction with a target. Such compounds serve as controls to identify other compounds with similar interactions. For example, it is relatively easy to obtain and screen large numbers of antibodies or other polypeptides for interaction with a target using phage display technology. However, antibodies or polypeptides are sometimes not suitable themselves for use as therapeutics, particularly for oral administration, due to their large size and tendency to be degraded in the intestine. The present methods allow one to identify small molecules equivalents that have similar interaction to an antibody or other polypeptide with a target, yet improved characteristics for pharmaceutical use, such as oral bioavailability.

In some methods, the identity of compounds to be screened is determined in advance before any modeling is performed. In other methods, the interaction is determined between one compound and a target, and the next compound to be screened is then designed in such a manner that it is expected that the second compound has improved interaction with the target. In some methods, the compounds to be screened represent variants of a kernel or lead compound. In other methods, compounds are essentially screened at random, for example, a collection of random peptides. The number of compounds that can be screened is significantly larger than in conventional methods. In conventional screening methods requiring synthesis and individualized screening of compounds, it can be extremely laborious to screen even a thousand compounds. By contrast, the present methods in which modeling of the interaction of a compound with a target can take much less time, orders of magnitude more compounds can be screened (e.g., 10⁴, 10⁶, 10⁸, 10¹⁰ or 10¹⁵).

The target against which compounds are screened can be a protein, a nucleic acid, a carbohydrate, a lipid, or an organic chemical structure among others. Often the target is a biological macromolecule, and interaction of compounds with the target is desired to induce a pharmacological effect via agonizing or antagonizing the target. The methods are particularly useful for screening for interactions of targets that lose their native conformation when isolated from their native environment, such as membrane-bound proteins. Targets of interest include antibodies, including anti-idiotypic antibodies and autoantibodies present in autoimmune diseases, such as diabetes, multiple sclerosis and rheumatoid arthritis. Other targets of interest are growth factor receptors (e.g., FGFR, PDGFR, EFG, NGFR, and VEGF) and their ligands. Other targets are G-protein receptors and include substance K receptor, the angiotensin receptor, the α- and β-adrenergic receptors, the serotonin receptors, and PAF receptor. See, e.g., Gilman, Ann. Rev. Biochem. 56:625-649 (1987). Other targets include ion channels (e.g., calcium, sodium, potassium channels), muscarinic receptors, acetylcholine receptors, GABA receptors, glutamate receptors, and dopamine receptors (see Harpold, U.S. Pat. No. 5,401,629 and U.S. Pat. No. 5,436,128). Other targets are adhesion proteins such as integrins, selecting, and immunoglobulin superfamily members (see Springer, Nature 346:425-433 (1990). Osborn, Cell 62:3 (1990); Hynes, Cell 69:11 (1992)). Other targets are cytokines, such as interleukins IL-1 through IL-13, tumor necrosis factors α & β, interferons α, β and γ, tumor growth factor Beta (TGF-β), colony stimulating factor (CSF) and granulocyte monocyte colony stimulating factor (GM-CSF). See Human Cytokines: Handbook for Basic & Clinical Research (Aggrawal et al. eds., Blackwell Scientific, Boston, Mass. 1991). Other targets are hormones, enzymes, and intracellular and intercellular messengers, such as, adenyl cyclase, guanyl cyclase, and phospholipase C. Drugs are also targets of interest. Target molecules can be human, mammalian or bacterial. Other targets are antigens, such as proteins, glycoproteins and carbohydrates from microbial pathogens, both viral and bacterial, and tumors. Still other targets are described in U.S. Pat. No. 4,366,241. Some agents screened by the target merely bind to a target. Other agents agonize or antagonize the target.

As a simple example of the methods, a protein can be evolved to have an improved binding affinity for a target. The methods can start with a wildtype or reference form of the protein whose primary amino sequence is known as is its three dimensional structure based on X-ray crystallography. The protein is known to bind a protein target whose primary amino acid sequence and three dimensional structure are likewise known. The interaction of the protein and a target is determined by solving equations of motions as described above. The interaction is then evaluated to determine the principal contacting residues of the protein and the target. The equations of motion are then re-solved for a variant of the protein having one or more amino acid substitutions relative to the wildtype protein. The key contacts are compared with those of the wildtype protein. The presence of additional contacts or shorter bond distances for the same contacts suggests a stronger binding affinity. Conversely, the presence of fewer contacting residues or longer bond distances suggests a weaker binding affinity. The process is repeated for additional variants. The variant or a subset of variants appearing to have the strongest affinity for the target are then synthesized and tested experimentally.

In another example, the methods of the invention can be used to humanize an antibody. An antibody has complementarity determining regions (CDRs) which are principally responsible for binding separated by variable region framework sequences. In conventional humanization procedures, one starts with a human acceptor antibody and a nonhuman (typically a mouse) donor antibody. The goal is to combine the CDRs from the nonhuman antibody with the framework regions from the human antibody (see Queen et al., Proc. Natl. Acad. Sci. USA 86:10029-10033 (1989) and WO 90/07861, U.S. Pat. Nos. 5,693,762, 5,693,761, 5,585,089, 5,530,101 and Winter, U.S. Pat. No. 5,225,539 (incorporated by reference in their entirety for all purposes). The unnatural juxtaposition of mouse CDR regions with human variable region residues can result in unnatural conformational restraints, which, unless corrected by substitution of certain amino acid residues, lead to loss of binding affinity. The selection of amino acid residues for substitution is determined by computer modeling. Modeling can be performed based on the primary amino acid sequence of the antibody alone or can include solved structures for related antibody chains or domains as starting points. The equations of motion are solved for the antibody chain to determine a three dimensional structure. The model indicates which framework amino acids most closely interact with the CDR regions. In general, framework amino acids within 6 A of a CDR region in the model are considered to interact with the CDR regions. The corresponding amino acids in the human acceptor antibody are then substituted with corresponding amino acids from the mouse donor antibody.

Following modeling and evaluation and comparison of the interactions of different compounds with the target, one or a subset of the screened compounds are selected for synthesis and biochemical assay. The nature of synthesis depends on the nature of the compounds. For example, conventional organic chemistry, recombinant DNA expression, solid phase peptide synthesis or solid phase synthesis can be used depending on the compound. The compounds are then screened for interaction with a target. If several compounds are to be tested simultaneously the assay can be performed in microwell plates. The assay can measure binding affinity or kinetics of the compounds with the target. In some methods, the assay measure binding specificity of a compound for the target in competition with a control compound known to interact with the target in a desired manner. In some methods, the assay measures a catalytic activity of the compounds on the target or vice versa. In some methods, the target is a cellular receptor, and the assay measures the capacity of a compound to transduce a signal through the receptor. In some methods, the assay is performed on an animal model of disease, such as a transgenic rodent designed to show symptoms of a human disease. The activity of the compound is determined from prevention, reduction or elimination of the symptoms of disease in the rodent. Compounds showing successful results in in vitro or animal studies can then be tested in human clinical trials, or can serve as a basis for design of further derivative compounds. Compounds surviving clinical trials are formulated with a pharmaceutical carrier for clinical use. The pharmaceutical carrier is manufactured in accordance with good manufacturing practices of the US FDA or similar agency in other countries. For parenteral administration, the carrier is sterile and substantially isotonic.

Therefore, while the foregoing is a complete description of the embodiments of the invention, it should be evident that various modifications, alternatives and equivalents may be made and used. Accordingly, the above description should not be taken as limiting the scope of the invention which is defined by the metes and bounds of the appended claims.

What is claimed is:

1. A method of modeling the behavior of a molecule, comprising
selecting a model for said molecule, said model having equations of motion for said molecule; and
integrating said model equations with an L-stable implicit integrator in large timesteps so as to obtain a calculations of said behavior of said molecule.

2. The method of claim 1 wherein said large timesteps comprise intervals of at least 200 femtoseconds.

3. The method of claim 2 wherein said integrating step is performed with varying timesteps.

4. The method of claim 1 further comprising
correcting for errors in said integrating step to obtain a history of states of said molecule over time.

5. The method of claim 1 wherein said selecting step includes selecting a stiff system model to obtain a history of states of said molecule over time.

6. The method of claim 1 wherein said integrating step includes avoiding energy conservation to obtain a minimum energy state for said molecule.

7. The method of claim 1 wherein said L-stable integrator comprises an integrator from the group comprising implicit Euler, Radau5, SDIRK3, SDIRK4, and other implicit Runge-Kutta methods.

8. The method of claim 3 further comprising
correcting for errors in said integrating step to obtain a history of states of said molecule over time.

9. The method of claim 3 wherein said selecting step includes selecting a stiff system model to obtain a history of states of said molecule over time.

10. The method of claim 3 wherein said integrating step includes avoiding energy conservation to obtain a minimum energy state for said molecule.

11. The method of claim 1 wherein said model is described in internal coordinates selected to speed calculations of said behavior of said molecule.

12. The method of claim 11 wherein said model comprises a torsion angle, rigid body model of said molecule

13. A method of modeling the behavior of a molecule, comprising
selecting a model for said molecule, said model having equations of motion for said molecule; and
selecting an L-stable integrator;
integrating said model equations with said L-stable integrator in timesteps of intervals varying over a range of at least 100 so as to obtain a calculation of said behavior of said molecule.

14. The method of claim 13 wherein said timesteps comprise intervals of at least 200 femtoseconds.

15. The method of claim 14 wherein said L-stable integrator is selected to remove energy from said model; and wherein said model equations are integrated without energy conservation to obtain a minimum energy state of said molecule.

16. The method of claim 15 wherein said L-stable integrator comprises an implicit Euler integrator.

17. The method of claim 14 wherein said model equations are integrated with error correction so as to obtain a history of states of said molecule over time.

18. The method of claim 14 wherein said model is selected for stiff equations of motion so as to obtain a history of states of said molecule over time.

19. The method of claim 14 wherein said model is selected for stiff equations of motion and said model equations are integrated with error correction, so as to obtain a history of states of said molecule over time.

20. The method of claim 19 wherein said L-stable integrator comprises a Radau5 integrator.

21. The method of claim 14 wherein said L-stable integrator is selected from the group comprising implicit Euler, Radau5, SDIRK3, SDIRK4 and implicit Runge-Kutta methods.

22. The method of claim 14 wherein said model is described in internal coordinates selected to speed calculations of said behavior of said molecule.

23. The method of claim 22 wherein said model comprises a torsion angle, rigid body model of said molecule.

24. A method of modeling the behavior of a first molecule with a plurality of second molecules, comprising
selecting a first model for said first molecule, said model having equations of motion for said first molecule;
selecting a second model for each of said second molecules, said model having equations of motion for said second molecule;
selecting an L-stable integrator;
integrating said model equations with said L-stable integrator in timesteps of intervals varying in a range of at least 100 so as to obtain a calculations of said behavior of said first molecule with said plurality of second molecules.

25. The method of claim 24 wherein said model equations are described in internal coordinates selected to speed calculations of said behavior.

26. The method of claim 24 wherein said second molecule is selected from the group comprising salts, solvents, and other organic and inorganic compounds.

27. The method of claim 26 wherein said second molecule comprises water.

28. The method of claim 25 wherein said first molecule comprises a protein.

29. The method of claim 25 wherein said large timesteps comprise intervals of at least 200 femtoseconds.

30. The method of claim 29 wherein said L-stable integrator is selected to remove energy from said model; and wherein said model equations are integrated without energy conservation to obtain a minimum energy state of said molecule.

31. The method of claim 30 wherein said L-stable integrator comprises an implicit Euler integrator.

32. The method of claim 25 wherein said model equations are integrated with error correction so as to obtain a history of states of said molecule over time.

33. The method of claim 25 wherein said model is selected for stiff equations of motion so as to obtain a history of states of said molecule over time.

34. The method of claim 25 wherein said model is selected for stiff equations of motion and said model equations are integrated with error correction, so as to obtain a history of states of said molecule over time.

35. Computer code for modeling the behavior of a molecule on a computer, said code comprising
a first module defining a model for said molecule, said model including equations of motion for said molecule and
a second module integrating said equations of motions with an L-stable implicit integrator to obtain calculations of said behavior of said molecule.

36. The computer code of claim 35 wherein said second module integrates said equations of motion with varying timesteps.

37. The computer code of claim 36 wherein said timesteps vary in magnitude over a range of at least 100.

38. The computer code of claim 35 wherein said first module defines said model with internal coordinates.

39. The computer code of claim 38 wherein said internal coordinates comprise generalized coordinates and generalized speeds.

40. The computer code of claim 39 wherein said first module defines a rigid multibody, torsion-angle model for said molecule.

41. A method of screening a library of compounds for interaction with a target, comprising
(a) selecting a model for the interaction of a compound with the target, the model having equations of motion for the compound and the target;
(b) inputting data for a first of the library of compounds into the equations of motions;
(c) integrating said model equations with an L-stable integrator in large time steps so as to obtain a calculation of the motions of the target and the compound and thereby the interaction of the compound with the target;
(d) repeating (b) and (c) for each compound in the library;
(e) comparing the interactions of the compounds with the target;
(f) synthesizing a compound selected based on its interaction with the target.

42. The method of claim 41, wherein the library of compounds comprises a lead compound known to interact with the target and test compounds to be tested for interaction with the target.

53. The method of claim 42, wherein the lead compound is a polypeptide and the test compounds are small molecules.

44. The method of claim 43, wherein the lead compound is an antibody.

45. The method of claim 42, wherein one of the compounds is a lead compound known to interact with the target and the comparing step compares the interactions between the test compounds and the target with that of the lead compound with the target to select a test compound having a similar interaction with the target to that of the lead compound.

46. The method of claim 42, further comprising identifying the lead compound from a primary library by contacting the lead compound with the target and detecting interaction between the lead compound and the target.

47. The method of claim 41, wherein different repetitions of steps (b) and (c) are performed on first and second compounds, the second compound being selected based on the interaction of the first compound with the target.

48. The method of claim 41, further comprising testing the synthesized compound for interaction with the target.

49. The method of claim 48, wherein the testing is performed in vitro, in a nonhuman animal or in a human.

50. The method of claim 41, further comprising formulating the synthesized compound as a pharmaceutical composition.

51. The method of claim 41, further comprising determining data relating to the structure of at least one of the library of compounds and/or the target.

52. The method of claim 51, wherein the data are determined by X-ray crystallography.

53. The method of claim 51, wherein the data are determined by infra red or ultraviolet spectroscopy, or NMR.

54. The method of claim 41, wherein the compounds are selected from the group consisting of proteins, nucleic acids, polysaccharides, phospholipids, hormones, prostaglandins, steroids, and small molecules.

55. The method of claim 54, wherein the compounds are small molecules selected from the group consisting of beta-turn mimetics, aromatic compounds, heterocyclic compounds, benzodiazepines, oligomeric N-substituted glycines and oligocarbamates.

56. The method of claim 41, wherein the target is selected from the group consisting of proteins, nucleic acids, carbohydrates, and lipids.

57. The method of claim 56, wherein the target is a receptor.

58. The method of claim 57, wherein the target is a membrane-bound receptor.

59. The method of claim 41, further comprising inputting data for a solvent or matrix containing the target and/or compound that interacts with the target into the equations of motion.

60. The method of claim 59, wherein the matrix is a phospholipid membrane.

61. The method of claim 41, wherein the solvent is an aqueous solvent.

62. The method of claim 41, wherein the solvent is an organic solvent.

63. The method of claim 41, wherein the data comprises the identity of components of the compound.

64. The method of claim 63, wherein the data comprises the identity of atoms of the compound.

65. The method of claim 41, wherein the data comprises X-ray crystallographic data.

66. The method of claim 41, further comprising inputting an environmental factor into the equations of motion.

67. The method of claim 41, wherein the environmental factor is the temperature or pressure at which interaction between the compound and target is to be determined.

68. The method of claim 41, wherein the library of compounds comprises at least 10¹⁰ members.

69. The method of claim 41, wherein the library of compounds comprises at least 10⁵⁰ members.

70. The method of claim 41, wherein the integrating step determines a binding affinity between the compound and the target and the comparing step compares the binding affinities of different compounds with the target, and the synthesizing step synthesizes the compound with the highest affinity for the target.

71. The method of claim 41, wherein the integrating step determines an interaction between the compound and the target that indicates the compound binds to the target with an affinity of at least 10⁹ M⁻¹.

72. The method of claim 41, wherein the integrating step determines an interaction between the compound and the target that indicates the compound transduces a signal through the target.

73. The method of claim 41, wherein the compounds are potential detergents and the integrating step determines an interaction between the compound and the target that indicates the compound denatures the target.

74. A method of evolving a protein to have a desired functional property comprising:
(a) selecting a model for a reference form of the protein, the model having equations of motion for the protein;
(b) inputting data for an amino acid substitution of the protein into the equations of motions;
(c) integrating said model equations with an L-stable integrator in large time steps so as to obtain a calculation of the motions of the protein with the amino acid substitution;
(d) repeating steps (b) and (c) for additional amino acid substitutions;
(e) comparing the motions of proteins with different amino acid substitutions;
(f) synthesizing a protein with an amino acid substitution selected based on the comparison.

75. The method of claim 74, further comprising testing the selected synthesized protein for a desired functional property.

76. The method of claim 74, wherein the desired functional property is capacity to bind a target.

77. The method of claim 74, wherein the desired functional property is an enzymatic activity.

78. A method of humanizing an immunoglobulin chain, comprising:
(a) providing an amino acid sequence for an immunoglobulin chain comprising CDR regions from a mouse antibody and variable region frameworks from a human antibody;
(b) selecting a model for the immunoglobulin chain the model having equations of motion for the immunoglobulin chain;
(c) integrating the model equations with an L-stable integrator in large time steps so as to obtain a calculation of the motions of the immunoglobulin chain;
(d) determining from the model which amino acid residues in the variable framework region interact with the CDR regions;
(e) substituting one or more of the amino acid residues in the variable framework region that interact with the CDR regions with corresponding amino acids from the mouse antibody;
(f) synthesizing the immunoglobulin chain including the one or more amino acid residues.

79. The method of claim 78, further comprising testing the synthesized immunoglobulin chain for binding to a target.

80. A method of calculating behavior or properties of one or more molecules in specified circumstances, comprising
(a) mathematically modeling said molecules and their environment, said model having equations of motion for said molecules expressed in a reduced set of coordinates; and
(b) numerically integrating said model equations with an implicit integrator using large timesteps, said integrator having stability properties and stepsize selection methods permitting the use of said large timesteps in calculating said behavior or properties with accuracy sufficient for said circumstances.

81. The method of claim 80 wherein said large timesteps comprise an interval of at least 200 femtoseconds.

82. The method of claim 80 wherein said integrating step is performed with varying timesteps.

83. The method of claim 82 wherein said varying timesteps comprise one of at least 200 femtoseconds.

84. The method of claim 80 wherein said stepsize selection method comprises accuracy estimation.

85. The method of claim 80 wherein said stepsize selection method comprises convergence requirements.

86. The method of claim 80 wherein said stepsize selection method comprises energy dissipation requirements.

87. The method of claim 80 wherein said integrator has the L-stability property.

88. The method of claim 80 wherein said integrator comprises an integrator from the group comprising of L-stable members of order 2 or greater of the Radau, SDIRK, SIRK, or Rosenbrock families of integration methods.

89. The method of claim 87 wherein said L-stable integrator comprises the Radau5 integration method.

90. The method of claim 80 wherein said integrator comprises an integrator from the group comprising DASSL and other implicit multistep methods designed for stiff or differential-algebraic systems.

91. The method of claim 80 wherein said coordinates are reduced by the use of one or more rigid bodies comprising two or more atoms each, and internal coordinates.

92. The method of claim 91 wherein the internal coordinates comprise torsion angles.

93. The method of claim 80 wherein said coordinates are reduced by the use of substructuring a molecule into rigid or flexible subcomponents.

94. The method of claim 80 wherein said environment comprises a vacuum.

95. The method of claim 80 wherein said environment comprises a solvent.

96. The method of claim 95 wherein said solvent comprises an implicit representation.

97. The method of claim 96 wherein said implicit solvent comprises non-uniform solvent properties such as membrane regions.

98. The method of claim 80 wherein said circumstances comprise a dynamic simulation.

99. The method of claim 98 wherein said circumstances comprise Newtonian dynamics.

100. The method of claim 98 wherein said circumstances comprise Langevin dynamics.

101. The method of claim 80 wherein said circumstances comprise the search for a reduced energy state of said molecules.

102. The method of claim 101 wherein said search comprises only the local energy basin of the starting configuration.

103. The method of claim 101 wherein said search comprises energy basins other than the local basin of the starting configuration.

104. The method of claim 80 wherein said molecule comprises a single biopolymer in a non-native circumstance, and said properties comprise the folded native structure of said biopolymer.

105. The method of claim 104 wherein said biopolymer is a polypeptide or protein.

106. The method of claim 104 wherein said biopolymer is a nucleic acid.

107. The method of claim 80 wherein said molecules comprise a target molecule and a ligand molecule where said behavior comprises binding of ligand to target or said properties comprise binding affinity, binding preferences, binding rates or other binding properties.
